(19) United States
(12) Patent Application Publication
(10) Pub. No.: US 2024/0056936 A1
(43) Pub. Date: Feb. 15, 2024

(54) COMMUNICATION DEVICE AND COMMUNICATION METHOD

(71) Applicant: SONY GROUP CORPORATION, TOKYO (JP)

(72) Inventors: KOSUKE AIO, TOKYO (JP); KEN TANAKA, TOKYO (JP); KAZUYUKI SAKODA, TOKYO (JP)

(21) Appl. No.: 18/258,290

(22) PCT Filed: Dec. 10, 2021
(86) PCT No.: PCT/JP2021/045491

§ 371 Date: Jun. 19, 2023

(30) Foreign Application Priority Data
Dec. 25, 2020 (JP) 2020-216941

(51) Int. Cl. H04W 40/04; H04W 40/12

(52) U.S. Cl. CPC H04W 40/04; H04W 40/12

(57) ABSTRACT

The present technology relates to a communication device and a communication method which make it possible to determine an optimum transmission route. Provided is a communication device including a control unit that performs control for exchanging information used to determine a multi-hop transmission route with another communication device using wireless communication, and determining an optimum transmission route based on the amount of transmission data increased at the time of performing processing by a plurality of communication devices in cooperation when the transmission route is determined based on the information. The present technology can be applied to, for example, equipment that constitutes a wireless LAN system.

### TECHNICAL FIELD

The present technology relates to a communication device and a communication method, and more particularly to a communication device and a communication method which are capable of determining an optimum transmission route.

### BACKGROUND ART

In recent years, there has been an increase in environments where a plurality of access points (APs) for a wireless local area network (LAN) are installed in stadiums and homes, and multi-AP coordination technology is attracting attention to improve a system throughput and reliability by coordination of the access points.

Joint Detection, one of these techniques, realizes uplink multiuser multiple-input and multiple-output (UL MU-MIIVIO) in which uplink signals from a wireless terminal (STA: STAtion) are received at a plurality of access points and aggregated, and reception computation processing is performed at any one of the access points, thereby using reception antennas for the cooperating access points. Thereby, uplink (UL: Uplink) signals can be acquired from many wireless terminals at once to improve a throughput and achieve low-delay transmission.

In addition, a multi-hop network using a multi-hop technique for transmitting data to a destination by passing through (hopping) a plurality of nodes is known. For example, PTL 1 discloses a technique for setting a mesh path (communication route) by measuring or calculating a path metric value in a mesh network, which is a network for performing a multi-hop.

### CITATION LIST

### Patent Literature

[PTL 1]
JP 2015-046661A

### SUMMARY

### Technical Problem

In order to realize Joint Detection, at least one access point has to transmit data that has not been subjected to demodulation processing (hereinafter referred to as Pre-demodulated Data) to other access points. In general, Pre-demodulated Data is expected to have an amount of information equal to or greater than that of transmission data of the existing method, and a backhaul link between access points may easily become congested.

For this reason, in a multi-hop network, in order to determine which access point aggregates Pre-demodulated Data and performs reception computation processing to perform demodulation processing and decoding processing, the role of each access point and a route of a backhaul link are optimized, and it is important to maximize an effective rate of the backhaul link.

In a multi-hop network of the existing method, for example, as disclosed in PTL 1, it is common to introduce an algorithm that measures or calculates a metric value of each path and determine optimum routing. However, in routing control in Joint Detection, some paths have to transmit Pre-demodulated Data with a large amount of information, and thus a routing determination method is significantly different.

The present technology has been made in view of such circumstances and makes it possible to determine an optimum transmission route.

### Solution to Problem

A communication device according to one aspect of the present technology is a communication device including a control unit that performs control for exchanging information used to determine a multi-hop transmission route with another communication device using wireless communication, and determining an optimum transmission route based on an increase in the amount of transmission data at the time of performing processing by a plurality of communication devices in cooperation when the transmission route is determined based on the information.

A communication method according to one aspect of the present technology is a communication method performed by a communication device that exchanges information used to determine a multi-hop transmission route with another communication device using wireless communication, and determines an optimum transmission route based on the amount of transmission data increased at the time of performing processing by a plurality of communication devices in cooperation when the transmission route is determined based on the information.

In the communication device and the communication method according to the aspects of the present technology, information used to determine a multi-hop transmission route is exchanged with another communication device using wireless communication, and an optimum transmission route is determined based on the amount of transmission data increased at the time of performing processing by a plurality of communication devices in cooperation when the transmission route is determined based on the information.

A communication device according to one aspect of the present technology is a communication device including a control unit that receives a trigger signal which is transmitted from another communication device included in a plurality of communication devices that perform processing in cooperation in a multi-hop network, and transmits an uplink signal including a flag indicating execution of coordination processing and a PHY header in which node identification information according to a role of processing when the coordination processing is performed is set.

In the communication device according to the aspect of the present technology, a trigger signal which is transmitted from another communication device included in a plurality of communication devices that perform processing in cooperation in a multi-hop network is received, and an uplink signal including a flag indicating execution of coordination processing and a PHY header in which node identification information according to a role of processing when the coordination processing is performed is set is transmitted.

Note that the communication device according to one aspect of the present technology may be an independent device or an internal block constituting one device.

### BRIEF DESCRIPTION OF DRAWINGS

FIG. 1 is a diagram illustrating a configuration example of a wireless LAN system to which the present technology is applied.

FIG. 2 is a block diagram illustrating a configuration example of a communication device to which the present technology is applied.

FIG. 3 is a diagram illustrating a reception operation in a signal processing unit of a wireless communication unit in FIG. 2.

FIG. 4 is a diagram illustrating an outline of Joint Detection.

FIG. 5 is a sequence diagram illustrating exchanges between devices along a time axis according to a first embodiment.

FIG. 6 is a diagram illustrating a configuration example of a JD Path Discovery Request Frame.

FIG. 7 is a diagram illustrating a configuration example of a JD Path Discovery Response Frame.

FIG. 8 is a flowchart illustrating a flow of processing when a JD Path Discovery Request Frame is received.

FIG. 9 is a flowchart illustrating a flow of processing when a JD Path Discovery Request Frame is transmitted.

FIG. 10 is a diagram illustrating a first example of links between nodes.

FIG. 11 is a diagram illustrating an example of a route table of a Relay3 in the case of the links between the nodes in FIG. 10.

FIG. 12 is a diagram illustrating a second example of links between nodes.

FIG. 13 is a diagram illustrating an example of a route table of a Source in the case of the links between the nodes in FIG. 12.

FIG. 14 is a flowchart illustrating a flow of processing when a JD Path Discovery Response Frame is transmitted.

FIG. 15 is a flowchart illustrating a flow of processing when a JD Path Discovery Response Frame is received.

FIG. 16 is a diagram illustrating a third example of links between nodes.

FIG. 17 is a diagram illustrating an example of a route table of a Relay3 in the case of the links between the nodes in FIG. 16.

FIG. 18 is a diagram illustrating a fourth example of links between nodes.

FIG. 19 is a diagram illustrating an example of a route table of a Relay1 in the case of the links between the nodes in FIG. 18.

FIG. 20 is a diagram illustrating a configuration example of a JD Setup Frame.

FIG. 21 is a diagram illustrating a configuration example of a JD UL Trigger.

FIG. 22 is a diagram illustrating a configuration example of a JD UL Data Frame.

FIG. 23 is a flowchart illustrating a flow of processing in a sharing node.

FIG. 24 is a flowchart illustrating a flow of processing in a shared node.

FIG. 25 is a flowchart illustrating a flow of processing when Joint Detection is performed.

FIG. 26 is a diagram illustrating an example of links between nodes when normal data transmission is performed.

FIG. 27 is a diagram illustrating an example of links between nodes when Joint Detection is performed.

FIG. 28 is a diagram illustrating a configuration example of a JD Path Discovery Request Frame.

FIG. 29 is a diagram illustrating a configuration example of a JD Path Discovery Response Frame.

FIG. 30 is a flowchart illustrating a flow of processing when a JD Path Discovery Request Frame is received.

FIG. 31 is a diagram illustrating a fifth example of links between nodes.

FIG. 32 is a diagram illustrating an example of a route table of a Relay1 in the case of the links between the nodes in FIG. 31.

FIG. 33 is a flowchart illustrating a flow of processing in a sharing node.

FIG. 34 is a diagram illustrating a first example of links between nodes when Joint Detection is performed with other nodes.

FIG. 35 is a diagram illustrating an example of a route table in the case of the links between the nodes in FIG. 34.

FIG. 36 is a diagram illustrating a second example of links between nodes when Joint Detection is performed with other nodes.

FIG. 37 is a diagram illustrating an example of a route table in the case of the links between the nodes in FIG. 36.

FIG. 38 is a diagram illustrating another configuration example of a wireless LAN system to which the present technology is applied.

FIG. 39 is a sequence diagram illustrating exchanges between devices along a time axis according to a third embodiment.

FIG. 40 is a sequence diagram illustrating exchanges between devices along a time axis according to the third embodiment.

FIG. 41 is a diagram illustrating a configuration example of an Inter-Node Link Metric Request.

FIG. 42 is a diagram illustrating a configuration example of an Inter-Node Link Metric Response.

FIG. 43 is a diagram illustrating a configuration example of an Inter-Node Link Metric Query.

FIG. 44 is a diagram illustrating a configuration example of a Joint Detection Setup Request.

FIG. 45 is a diagram illustrating a configuration example of a Joint Detection Setup Response.

### DESCRIPTION OF EMBODIMENTS

(System Configuration Example)

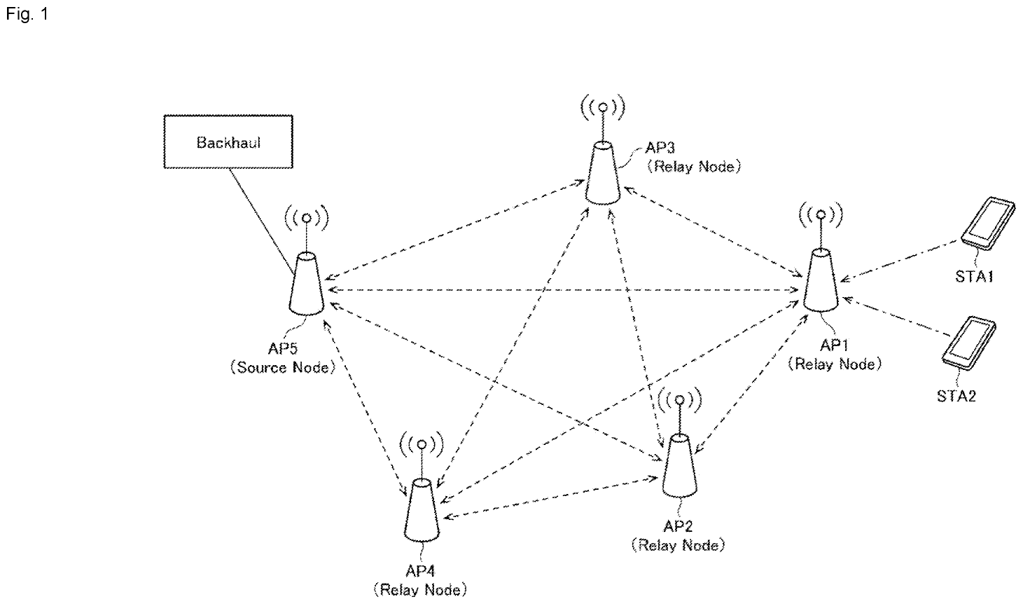

FIG. 1 is a diagram illustrating a configuration example of a wireless LAN system to which the present technology is applied.

In FIG. 1, the wireless LAN system includes five access points AP1 to AP5 and two wireless terminals STA1 and STA2. The access points AP construct a mesh network as a multi-hop network.

Hereinafter, an access point AP connected to a backhaul will be referred to as a source node, and another access point AP will be referred to as a relay node. In FIG. 1, an access point AP5 serves as a source node, and access points AP1 to AP4 serve as relay nodes 1 to 4 (Relay 1 to Relay 4).

It is assumed that each relay node relays an acquired UL signal to the source node, and existing methods can be used for a transmission route at that time. Note that both the source node and the relay node perform cell formation, and the wireless terminals STA are connected under them. Hereinafter, for simplification of description, an operation when the wireless terminals STA1 and STA2 under the control of the access point AP1 (Relay 1) perform UL signal transmission will be described, but the wireless terminal STA under the control of any access point AP may perform UL signal transmission as an operation to which the present technology is applied.

Note that a target system configuration is not limited to the configuration illustrated in FIG. 1, it only being required that there be a plurality of communication devices with established connections, and that there is a communication device as a peripheral terminal for each of the communication devices, and a positional relationship does not matter as long as the above-described conditions are satisfied.

(Configuration Example of Device)

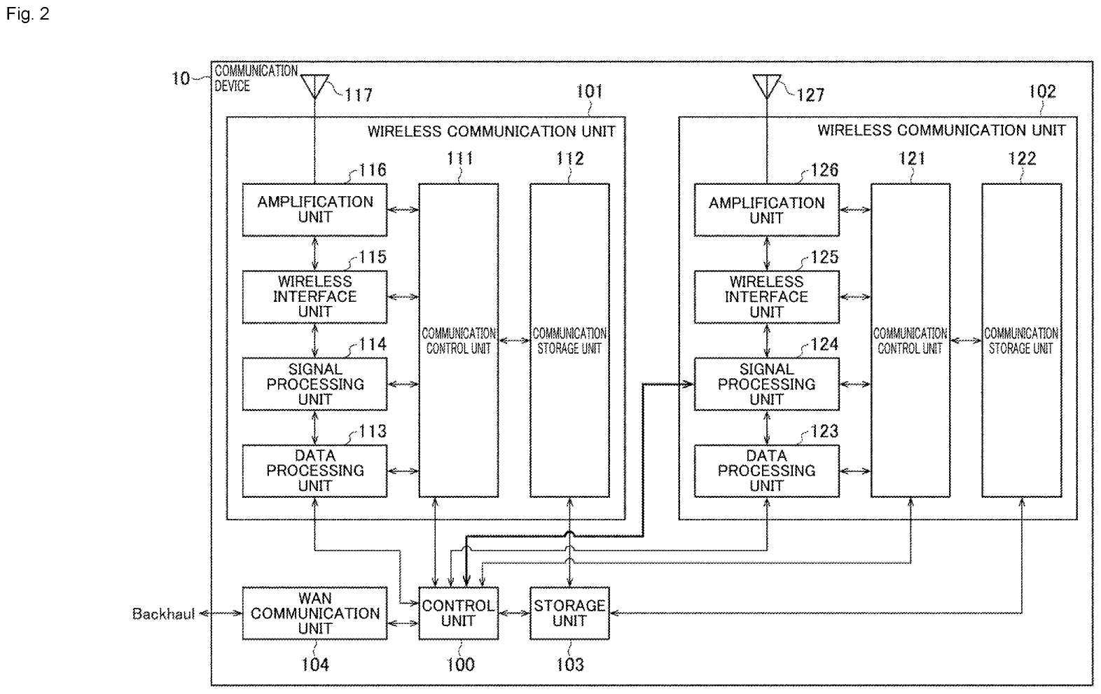

FIG. 2 is a diagram illustrating a configuration example of a communication device to which the present technology is applied.

The communication device 10 is configured as the access point AP in FIG. 1. A communication device 10 includes a control unit 100, a wireless communication unit 101, a wireless communication unit 102, a storage unit 103, and a WAN communication unit 104. In addition, an antenna 117 and an antenna 127 are connected to the wireless communication unit 101 and the wireless communication unit 102, respectively.

The wireless communication unit 101 is a wireless communication unit for communication between the access points AP (for communication between APs). The wireless communication unit 101 includes a communication control unit 111, a communication storage unit 112, a data processing unit 113, a signal processing unit 114, a wireless interface unit 115, and an amplification unit 116.

The communication control unit 111 controls the operation of each unit and information transmission between the units. Further, the communication control unit 111 performs control for transferring control information and management information, which are to be notified to other communication devices, to each data processing unit 113.

The communication storage unit 112 stores information used by the communication control unit 111. Further, the communication storage unit 112 stores packets to be transmitted and packets received. Note that a transmission buffer that stores packets to be transmitted is included in the communication storage unit 112.

At the time of transmission, the data processing unit 113 performs sequence management of data stored in the communication storage unit 112 and control information and management information received from the communication control unit 111, and performs encryption processing and the like and then adds a media access control (MAC) header and an error detection code to generate a packet. The data processing unit 113 performs processing for connecting a plurality of packets generated. Further, the data processing unit 113 performs disconnection processing of the MAC header of the received packet, analysis and error detection, and retransmission request operation reordering processing at the time of reception.

At the time of transmission, the signal processing unit 114 performs coding, interleaving, modulation, and the like on the packet and adds a PHY (Physical) header to generate a symbol stream. In addition, at the time of reception, the signal processing unit 114 analyzes the PHY header, and performs demodulation, deinterleaving, decoding, and the like on the symbol stream to generate a packet. The signal processing unit 114 performs estimation of complex channel characteristics and spatial separation processing as necessary.

At the time of transmission, the wireless interface unit 115 performs digital-analog signal conversion, filtering, up-conversion, and phase control on the symbol stream to generate a transmission signal. In addition, at the time of reception, the wireless interface unit 115 performs down-conversion, filtering, and analog-to-digital signal conversion on the received signal to generate a symbol stream.

The amplification unit 116 amplifies a signal input from the wireless interface unit 115 or the antenna 117. A portion of the amplification unit 116 may be an external component of the wireless communication unit 101. In addition, a portion of the amplification unit 116 may be included in the wireless interface unit 115.

The wireless communication unit 102 is a wireless communication unit for communication between the access point AP and the wireless terminal STA (for AP-STA communication). The wireless communication unit 102 includes a communication control unit 121, a communication storage unit 122, a data processing unit 123, a signal processing unit 124, a wireless interface unit 125, and an amplification unit 126.

The wireless communication unit 102 for AP-STA communication is configured in the same manner as the wireless communication unit 101 for AP-AP communication. For this reason, regarding the internal configuration of the wireless communication unit 102, in the description of the internal configuration of the wireless communication unit 101 described above, the communication control unit 111 to the amplification unit 116 may be read as the communication control unit 121 to the amplification unit 126, respectively.

However, although it is assumed that the wireless communication unit 101 and the wireless communication unit 102 have exactly the same internal configuration, they may have slightly different configurations. In addition, transmission parameters of both (a center frequency, a bandwidth, a maximum transmission power value, the number of antennas, and the like) do not have to match.

The control unit 100 controls the wireless communication units 101 and 102 and the communication control units 111 and 121. In addition, the control unit 100 may perform some of the operations of the communication control units 111 and 121 instead. Note that the control unit 100 and the communication control units 111 and 121 may be configured as one block.

The storage unit 103 stores information to be used by the control unit 100 and the wireless communication units 101 and 102. In addition, the storage unit 103 may perform some of the operations of the communication storage units 112 and 122 instead. The storage unit 103 and the communication storage units 112 and 122 may be configured as one block.

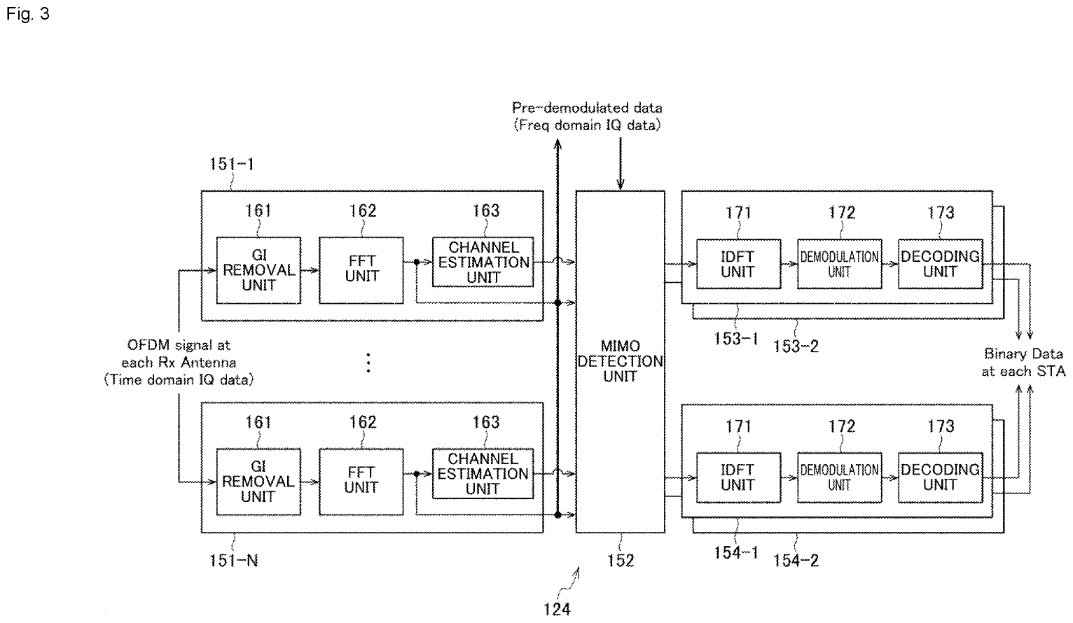

Further, in the present technology, it is necessary to transmit Pre-demodulated Data, which is data in the middle of processing in the signal processing unit 124 in the wireless communication unit 102, to another access point AP, and thus information is required to be exchanged directly from the signal processing unit 124 to the control unit 100 as illustrated in FIG. 2. Regarding the Pre-demodulated Data received by the control unit 100, a transmission signal is generated by performing processing according to the existing method on quantized information by the wireless communication unit 101 and is transmitted to another access point AP. In contrast, the Pre-demodulated Data acquired from another access point AP is transferred to the signal processing unit 124 of the wireless communication unit 102 through the control unit 100, and reception processing is continued with the information added. Details will be described later with reference to FIG. 3.

Note that the Pre-demodulated Data may be temporarily stored in the storage unit 103 as necessary. In addition, data exchange may be performed directly within the wireless communication units 101 and 102 without going through the control unit 100 or the storage unit 103.

The WAN communication unit 104 decodes the packet acquired from the backhaul and transfers it to the wireless communication units 101 and 102 through the control unit 100. As for the format of the packet transferred here, it does not matter whether an IP header is left as it is (access point mode) or the IP header is decoded and removed by the WAN communication unit 104 (router mode).

Note that, in FIG. 2, each of the wireless communication units 101 and 102 is assumed to be configured as one integrated circuit (IC), but the configuration of an IC to which the present technology is applied is not limited thereof. For example, each of the wireless interface units 115 and 125 may be mounted as a separate IC.

FIG. 3 is a diagram illustrating a reception operation in signal processing unit 124 of the wireless communication unit 102 in FIG. 2.

In the signal processing unit 124, processing units 151-1 to 151-N (N is an integer of 1 or more) are provided at a stage preceding the MIMO detection unit 152, and processing units 153-1 and 153-2 and processing units 154-1 and 154-2 are provided at a stage subsequent thereto. The processing unit 151 includes a GI removal unit 161, an FFT unit 162, and a channel estimation unit 163. Each of the processing units 153 and 154 includes an IDFT unit 171, a demodulation unit 172, and a decoding unit 173.

In the signal processing unit 124, first, a symbol stream is removed from the wireless interface unit 125, that is, Guard Interval (GI) is removed by a GI removal unit 161 from an orthogonal frequency division multiplexing (OFDM) signal (UQ data on a time axis) acquired by each reception antenna, and the signal is converted into a signal on a frequency axis through fast fourier transform (FFT) by the FFT unit 162.

Thereafter, the channel estimation unit 163 estimates frequency characteristics from a known symbol in the PHY header, and the MIMO detection unit 152 performs MIMO processing and separation into received signals of respective streams by using the Pre-demodulated Data (UQ data on the frequency axis) acquired from the reception antennas and channel estimation results. Thereafter, inverse discrete fourier transform (IDFT) processing of the IDFT unit 171, demodulation processing of the demodulation unit 172, and decoding processing of the decoding unit 173 are performed for each stream, and thus the received signals acquired from the wireless terminals STA are acquired in the format of Binary Data. The acquired data is supplied to the data processing unit 123.

The signal processing unit 124 is characterized in that a path for exchanging Pre-demodulated Data is added immediately before the MIMO detection unit 152 in order to perform Joint Detection. This path is connected to the control unit 100 as described above.

(Outline of Joint Detection)

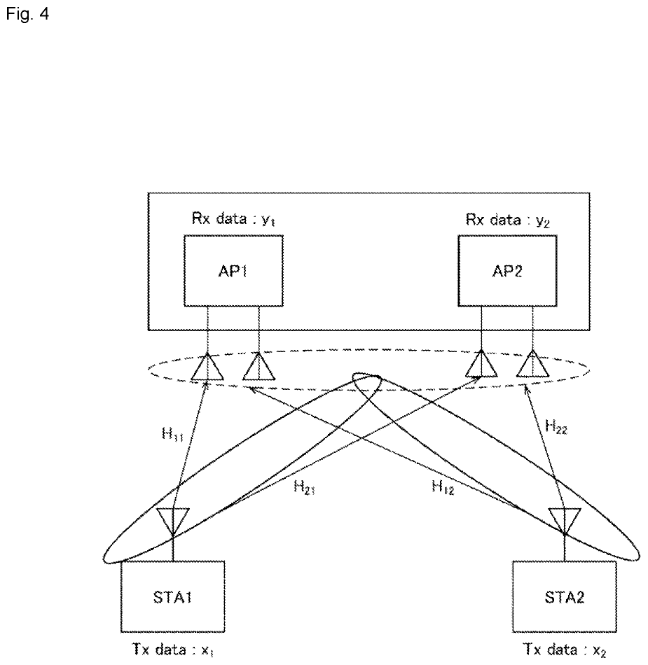

FIG. 4 is a diagram illustrating an outline of Joint Detection.

Joint Detection is a technique in which a plurality of access points AP cooperate with each other to perform UL MU-MIMO processing as one access point AP. Hereinafter, Joint Detection will also be referred to as JD as appropriate. For example, in a case where the wireless terminals STA1 and STA2 can be connected to the access points AP1 and AP2, received data of each access point AP is normally represented by the following Formula (1), provided that in Formula (1), W represents a reception weight.

$$\begin{matrix}[ Math . 1 ] & \\ [ \begin{matrix}{y}_{1} \\ {y}_{2}\end{matrix} ] = W \cdot [ \begin{matrix}{H}_{11} & {H}_{21} \\ {H}_{12} & {H}_{22}\end{matrix} ] [ \begin{matrix}{X}_{1} \\ {X}_{2}\end{matrix} ] & ( 1 )\end{matrix}$$

In UL MU-MIMO of the existing method, when the access point AP acquires UL Data of both the wireless terminals STA1 and STA2, the number of reception antennas has to be at least equal to or more than a total number of transmission streams of the wireless terminals STA that perform UL transmission. For example, in a case where the wireless terminals STA transmit two streams, the access point AP needs at least four reception antennas. In the case of fewer than this number of reception antennas, the access point AP cannot completely separate streams from the wireless terminals STA, and there is a high possibility that communication quality will deteriorate significantly in association with a decrease in reception power, interference, and an increase in noise power. In contrast, the number of simultaneous transmission terminals and the number of streams on the wireless terminal STA side are limited by the number of reception antennas of the access points AP.

On the other hand, when Joint Detection is performed, the number of reception antennas is equivalent to a total number of reception antennas included in the access points AP cooperating with each other. That is, for example, in a case where the wireless terminals STA transmit two streams, the access points AP can separate transmission streams only by having two reception antennas in Joint Detection performed by two access points AP. In contrast, with an increase in the total number of reception antennas through Joint Detection, the number of simultaneous transmission terminals and the number of streams that can be transmitted on the wireless terminal STA side increase, and a significant improvement in wireless capacity can be expected.

As described above, in a case where Joint Detection is performed by two access points AP, one access point AP has to transmit Pre-demodulated Data to the other access point AP. The data has to be transmitted in the form of quantized numerical values that can be represented by UQ on a frequency axis, and it is assumed that the amount of information to be transmitted will increase as compared to Binary Data of the existing method. Further, quantization bits of the Pre-demodulated Data can vary depending on transmission parameters (transmission bandwidth, modulation and coding scheme (MCS), and the like) of a UL signal.

Thus, in a multi-hop network as illustrated in FIG. 1, an optimum transmission route and its role when Joint Detection is performed have to be determined by a method different from path route determination in the existing method. Roles at the time of performing Joint Detection include a side that transmits Pre-demodulated Data (hereinafter referred to as a supplier) and a side that acquires Pre-demodulated Data (hereinafter referred to as a detector). Consequently, the present technology provides a method of dynamically determining a path route and the roles of the detector and the supplier at the time of performing Joint Detection from transmission parameters of a UL signal.

### 1. First Embodiment

(Overall Sequence Diagram)

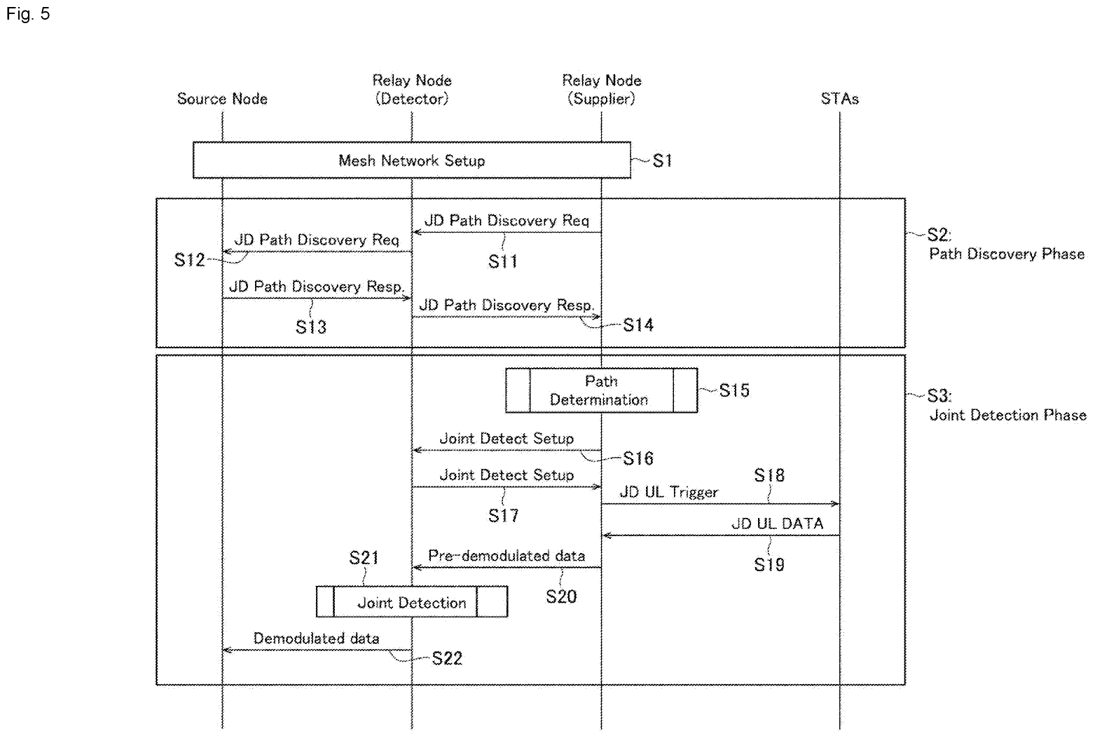

FIG. 5 is a sequence diagram illustrating exchanges between devices along a time axis according to a first embodiment. Description will be given by dividing this sequence diagram into three phases, that is, a Mesh Network Phase (S1), a Path Discovery Phase (S2), and a Joint Detection Phase (S3).

In the Mesh Network Phase (S1), a mesh network is constructed between a source node and each relay node, and a transmission route is determined during a normal operation (when Joint Detection is not performed). Since the operations in this phase are the same as those in the existing method, a detailed description will be omitted.

In the Path Discovery Phase (S2), a transmission route is determined when Joint Detection is performed. In the Path Discovery Phase, processing starts when a certain relay node transmits a JD Path Discovery Request (S11). A node that has received the JD Path Discovery Request calculates a metric value, updates shortest route information, and then transmits the updated JD Path Discovery Request when acquiring the next transmission right (S12).

This is performed within a predetermined period, and a path serving as a minimum metric from the JD Path Discovery Request finally acquired by a destination node of Path Discovery (the source node in FIG. 5) is determined as a route from a relay node starting this processing to itself (or vice versa). Thereafter, JD Path Discovery Responses are transmitted in order by reversely following the route determined from the destination node (S13, S14).

Here, the node that starts this processing is referred to as an originator, and a final destination for which a transmission route is desired to be determined is referred to as a target. Note that, for example, the source node may be the originator, and the target may be the relay node.

A route searching method taking Joint Detection into consideration differs from the existing method in that a calculation method for some metrics is different, and that metric calculation and shortest route calculation are performed for each detector candidate node when a node itself operates as a supplier. Details of these calculation methods will be described later.

In the Joint Detection Phase (S3), a node that has acquired a transmission right receives and decodes a UL signal using a coordination operation (Joint Detection) with other nodes from the wireless terminal STA under its control, and then transmits the acquired data to the source node through the determined transmission route.

First, the relay node determines cooperating access points AP and their roles (detector and supplier) from the wireless terminal STA that induces UL transmission and the route and its metric value acquired in the Path Discovery Phase (S2) (S15). Details of this determination method will be described later.

Next, after Joint Detect Setup is exchanged between the cooperating nodes (S16, S17), UL Data (JD UL DATA) for Joint Detection is acquired from the wireless terminal STA by a JD UL Trigger (S18, S19). Then, the supplier determined at the time of setup supplies the Pre-demodulated Data to the detector (S20), Joint Detection processing is performed (S21), and the Demodulated Data is transmitted to the source node (S22).

Note that FIG. 5 illustrates a sequence diagram when the supplier acquires a transmission right, but when the detector acquires the transmission right, the Path Determination (S15) becomes processing on the detector side, and the arrows of the Joint Detect Setup (S16, S17) are reversed.

(S2: Path Discovery Phase)

Details of the Path Discovery Phase (S2 in FIG. 5) in the overall sequence diagram will be described. Here, a configuration example of a frame used in the Path Discovery Phase and a flowchart illustrating a flow of processing will be described.

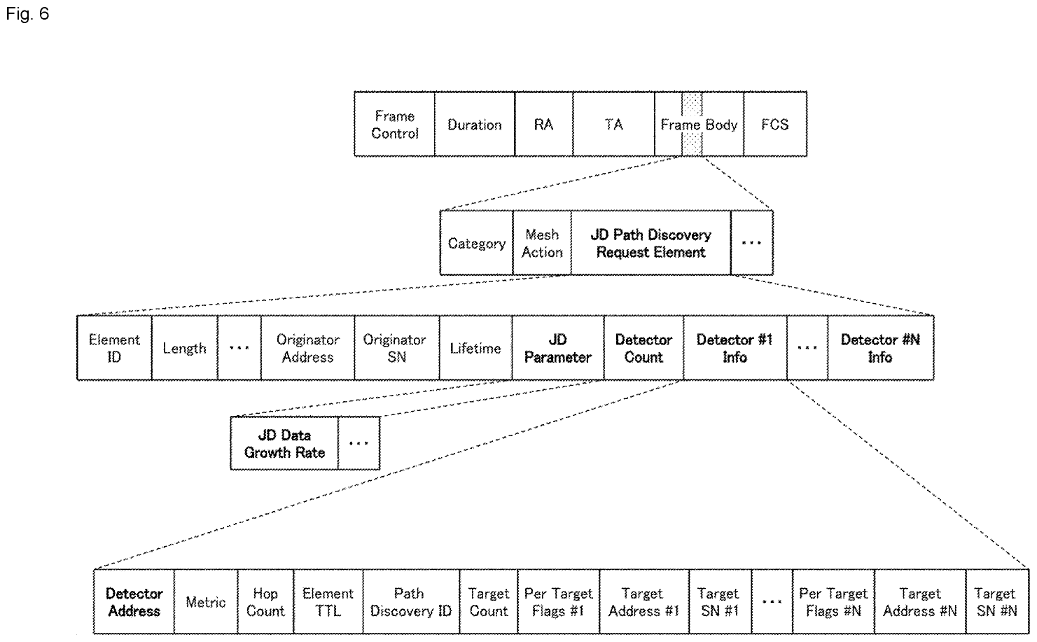

FIG. 6 is a diagram illustrating a configuration example of a JD Path Discovery Request Frame.

The JD Path Discovery Request Frame is constituted by Frame Control, Duration, RA, TA, Frame Body, and FCS. Here, a configuration based on a Mesh Action Frame and a PREQ Element specified in institute of electrical and electronics engineers (IEEE) 802.11s is shown.

The Frame Control includes information indicating the type of frame. The Duration includes information indicating the length of the frame. The RA (Receiver Address) includes a transmission destination address. The TA (Transmitter Address) includes a transmission source address.

The Frame Body includes the body of information to be transmitted. In the first embodiment, the body information includes a Mesh Action Frame. In addition, the FCS (Frame Check Sequence) is added as an error correction code. The Mesh Action Frame includes fields of Category, Mesh Action, and JD Path Discovery Request Element.

The Category includes information indicating that the relevant Action Frame is a Mesh Action Frame. The Mesh Action includes information indicating that the Mesh Action Frame is a JD Path Discovery Request Frame. The JD Path Discovery Request Element includes an information group used for path detection for Joint Detection.

The JD Path Discovery Request Element includes fields of Element ID, Length, Originator Address, Originator SN, Lifetime, JD Parameter, Detector Count, and Detector Info.

The Element ID includes information indicating that the relevant element is a JD Path Discovery Request Element. The Length includes information indicating the length of the element. The Originator Address includes address information of an originator which is a Path Discovery request source. The Originator SN includes a Sequence Number (SN) of a path managed by the originator which is a Path Discovery request source. The Lifetime includes remaining time information for collecting and transmitting a Path Discovery Request Frame.

The JD Parameter includes an information group necessary for path searching for Joint Detection. In the first embodiment, the information group includes at least a JD Data Growth Rate used for calculating a metric value. The Detector Count includes information on the number of detector candidates for path searching for Joint Detection. The Detector Info fields followed by a numerical value indicated in the relevant field are included. The Detector Info includes a path information group for each detector candidate node. The Detector Info includes fields of Detector Address, Metric, Hop Count, Element TTL, Path Discovery ID, Target Count, Per Target Flags, Target Address, and Target SN.

The Detector Address includes address information of a detector candidate node. The Metric includes a path metric value from the originator to itself through detector candidate nodes. A method of calculating the path metric value will be described later. The Hop Count includes the number of hops from the originator to itself through detector candidate nodes. The Element TTL includes information on the number of remaining hops. When the numerical value is 0, no further path searching is performed.

The Path Discovery ID includes identification information of the relevant Path Discovery processing. Note that, when the same ID is given to each detector, a notification may be given in the upper stage instead of in the relevant field. The Target Count includes information indicating the number of targets which are Path Discovery request destinations. The Per Target Flags, the Target Address, and the Target SN followed by a numerical value indicated by the Target Count are included.

The Per Target Flags is a flag indicating detailed information on a target which is a Path Discovery request destination. The Target Address includes address information of a target which is a Path Discovery request destination. The Target SN includes Sequence Number (SN) of a path which is a Path Discovery request destination but is managed. Note that, in a case where SN is unknown, the relevant field may be skipped. In that case, the presence or absence of the relevant field is notified by the flag in the Per Target Flags.

Note that the JD Path Discovery Request frame is not limited to the frame configuration illustrated in FIG. 6, and is only required to include at least one or more of JD Data Growth Rate, Detector Count, and Detector Info including Detector Address and Metric which are illustrated in the drawing. In addition, the frame is described assuming a MAC Frame, but may be transmitted as a TCP/IP Frame as long as the above-described information is described.

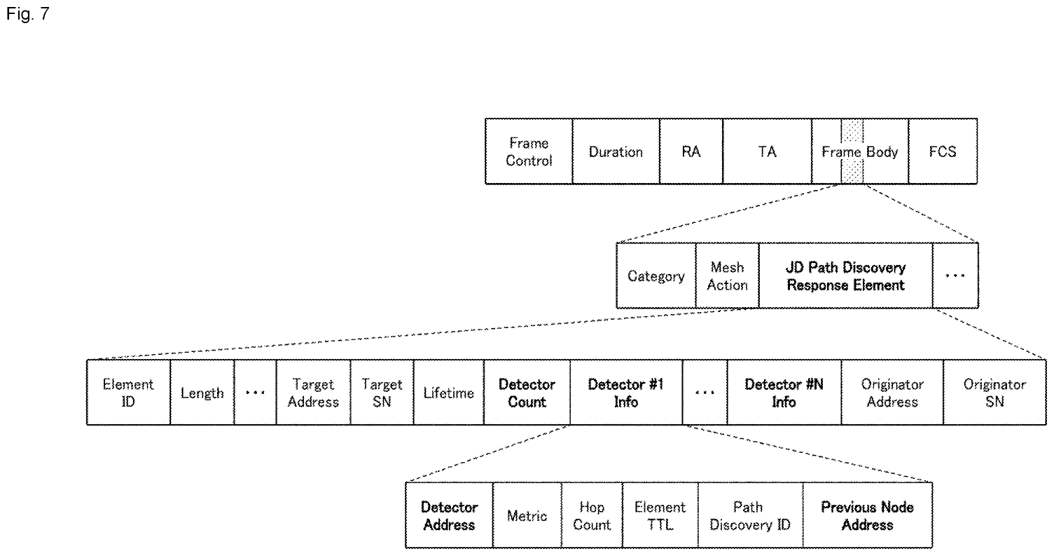

FIG. 7 is a diagram illustrating a configuration example of a JD Path Discovery Response Frame.

The JD Path Discovery Response Frame is constituted by Frame Control, Duration, RA, TA, Frame Body, and FCS. Here, a configuration based on a Mesh Action Frame and a PREP Element specified in IEEE802.11s is shown.

The Frame Control includes information indicating the type of frame. The Duration includes information indicating the length of the frame. The RA includes a transmission destination address. The TA includes a transmission source address. The Frame Body includes the body of information to be transmitted. In the first embodiment, the body information includes a Mesh Action Frame. In addition, FCS is added as an error correction code. The Mesh Action Frame includes fields of Category, Mesh Action, and JD Path Discovery Response Element.

The Category includes information indicating that the relevant Action Frame is a Mesh Action Frame. The Mesh Action includes information indicating that the Mesh Action Frame is a JD Path Discovery Response frame. The JD Path Discovery Response Element includes an information group regarding a determined path for Joint Detection.

The JD Path Discovery Response Element includes fields of Element ID, Length, Target Address, Target SN, Lifetime, Detector Count, Detector Info, Originator Address, and Originator SN.

The Element ID includes information indicating that the relevant element is a JD Path Discovery Response Element. The Length includes information indicating the length of the element. The Target Address includes address information of a target which is a Path Discovery request destination. The Target SN includes a Sequence Number (SN) of a path which is a Path Discovery request destination but is managed. The Lifetime includes remaining time information for collecting and transmitting a Path Discovery Response Frame.

The Detector Count includes information on the number of detector candidates for path searching for Joint Detection. The Detector Info fields followed by a numerical value indicated in the relevant field are included. The Detector Info includes a path information group for each detector candidate node. The Detector Info includes fields of Detector Address, Metric, Hop Count, Element TTL, Path Discovery ID, and Previous Node Address.

The Detector Address includes address information of a detector candidate node. The Metric includes a path metric value from a target to itself. A method of calculating the path metric value will be described later. The Hop Count includes the number of hops from the target to itself. The Element TTL includes information on the number of remaining hops. When the numerical value is 0, the frame is no longer transmitted.

The Path Discovery ID includes the same identification information as the Path Discovery Request. Note that, when the same ID is given to each detector, a notification may be given in the upper stage instead of in the relevant field. The Previous Node Address includes destination address information to which the frame will be transmitted next.

The Originator Address includes address information of an originator which is a Path Discovery request source. The Originator SN includes a Sequence Number (SN) of a path managed by the originator which is a Path Discovery request source.

Note that the JD Path Discovery Response Frame is not limited to the frame configuration illustrated in FIG. 7, and is only required to include at least one or more of Detector Count, and Detector Info including Detector Address, Metric, and Previous Node Address which are illustrated in the drawing. In addition, the frame is described assuming a MAC Frame, but may be transmitted as a TCP/IP Frame as long as the above-described information is described.

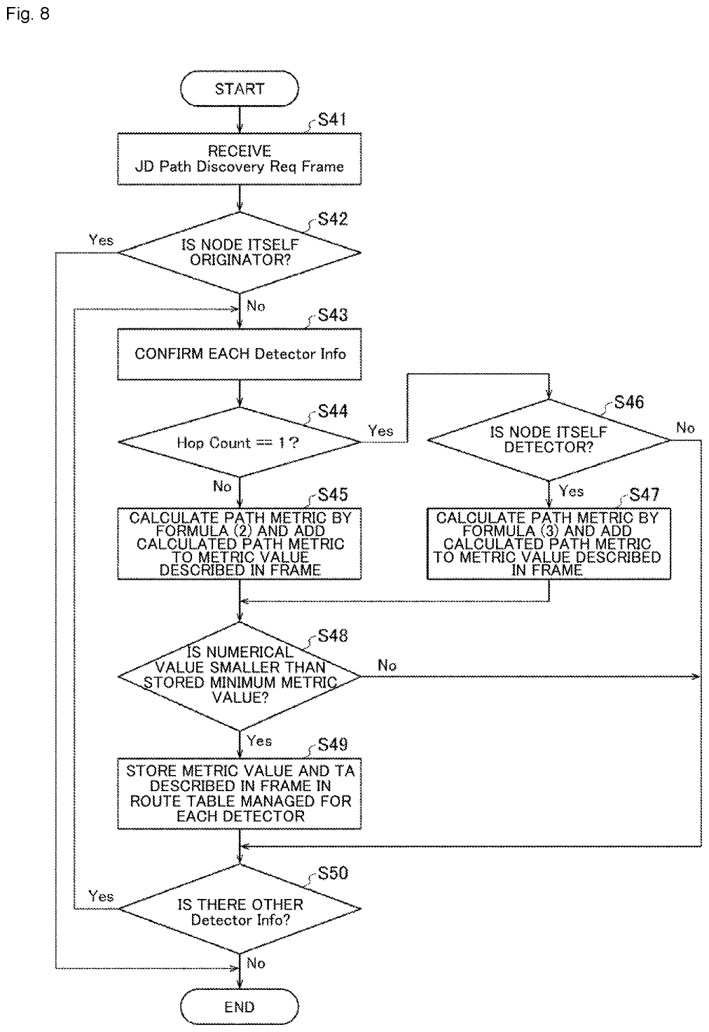

Next, a flow of processing at the time of receiving a JD Path Discovery Request Frame will be described with reference to a flowchart of FIG. 8.

First, in a case where the Originator Address in the JD Path Discovery Request Element of the received JD Path Discovery Request Frame indicates itself (Yes in S41 and S42), that is, in a case where the relay node is a Path Discovery request source, the processing is terminated by the relay node. On the other hand, in a case where the Originator Address does not indicate itself (No in S42), Detector Info in the frame is confirmed one by one (S43).

In a case where the Hop Count is not “1” for the confirmed Detector Info (No in S44), the relay node calculates a path metric from a transmission source of the frame to itself using Formula (2) to be described later and adds the calculated path metric to a metric value described in the frame (S45).

On the other hand, in a case where the Hop Count is “1” and the Detector Address indicates itself (Yes in S44, Yes in S46), the relay node calculates a path metric from a transmission source of the frame to itself using Formula (3) to be described later and adds the calculated path metric to a metric value described in the frame (S47).

When the processing of step S45 or S47 is terminated, the processing proceeds to step S48. The relay node compares metric values stored for the respective detector candidate nodes by itself, and when the numerical value calculated above is smaller (Yes in S48), the calculated metric value and the transmission source (TA) of the frame are overwritten on a managed route table in association with the Detector Address (S49).

Note that the Hop Count is “1” and the Detector Address does not indicate itself (Yes in S44, No in S46), the processing for the confirmed Detector Info is terminated. This is because the first hop is necessarily addressed to the detector. In addition, when there is another Detector Info (Yes in S50), the processing returns to step S43, and the processing for the other Detector Info is continued.

Here, a formula for calculating the metric value described above will be described. First, a metric calculation formula of the existing method, that is, the metric calculation formula used in the processing of step S45 in FIG. 8 is as shown in Formula (2) below.

$$\begin{matrix}[ Math . 2 ] & \\ {C}_{a} = \cdot [ 0 + \frac{{B}_{t}}{r} ] \frac{1}{1 - {e}_{f}} & ( 2 )\end{matrix}$$

In Formula (2), parameters used for calculation are as follows.
Cₐ: Link Metric
O: Varies depending on PHY

An overhead value for channel access, including frame headers, training signals (STF/LTF, etc.), access protocol frames (RTS/CTS, etc.), and is a fixed value.
Bₜ: Test Payload

The number of bytes of a frame. A fixed value (8192 bytes) is used in IEEE802.11s.
r: Data Rate [Mbps]

A data rate value assumed to be used at the time of transmitting a Test Payload (Bₜ). The selection of a data rate is implementation-dependent.
e_{f}: Frame error rate

A probability that a frame will be damaged at the time of transmitting a Test Payload (B t) at a Data Rate (r). An estimation method is implementation-dependent.

Next, a metric calculation formula from a supplier to a detector at the time of performing Joint Detection, that is, the metric calculation formula used in the processing of step S47 in FIG. 8 is as shown in Formula (3) below.

$$\begin{matrix}[ Math . 3 ] & \\ {C}_{a} = \cdot [ 0 + \frac{α {B}_{t}}{r} ] \frac{1}{1 - {e}_{f}} & ( 3 )\end{matrix}$$

Here, in Formula (3), parameters added to the above Formula (2) are as follows.
α: JD Data Growth Rate

Compared to Demodulated data that is normally transmitted, the JD Data Growth Rate represents the rate of increase in the amount of information of Pre-demodulated Data that is transmitted during Joint Detection. The parameters are stored in the JD Path Discovery Request Frame by the originator, and each relay node that has received the frame uses a numerical value stored in the frame. Note that several methods of determining a JD Data Growth Rate are conceivable, and the JD Data Growth Rate may be calculated, for example, as in Formula (4) below.

$$\begin{matrix}[ Math . 4 ] & \\ α = \cdot \frac{{Q}_{JDi} + {Q}_{JDq}}{{N}_{BPSCS} * R} & ( 4 )\end{matrix}$$

Here, in Formula (4), parameters used for calculation are as follows.
Q_{JDi}: Quantization Bit of Pre-demodulated Data (“I” domain)
Q_{JDq} Quantization Bit of Pre-demodulated Data (“Q” domain)

Number of Quantization Bits of Pre-Demodulated Data

The number of quantization bits may be implementation-dependent, or may be standardized to use a standardized value.

Regarding the number of quantization bits, a different numerical value may be used for each MCS of UL transmission.

Quantization may be performed in an amplitude or a phase.
N_{BPSCS}: Number of coded bits per single carrier for each spatial stream
R: Coding Rate

Both N_{BPSCS} and R are uniquely determined by MCS.

For example, when a UL signal of MCS1 (N_{BPSCS}=2, R=½) is transmitted from the wireless terminal STA, Demodulated Data for each carrier is 2*½=1 [bit]. On the other hand, when Pre-demodulated Data transmitted by a supplier for Joint Detection is quantized with 5 bits for both received FQ signals of each carrier, a JD Data Growth Rate is α=(5+5)/1=10.

On the other hand, when a UL signal of MCS7 (N_{BPSCS}=5, R=5/6) is transmitted from the wireless terminal STA, the Demodulated Data for each carrier is 6*5/6=5 [bit]. On the other hand, when the Pre-demodulated Data transmitted by the supplier for Joint Detection is quantized with 5 bits for both received FQ signals of each carrier, a JD Data Growth Rate is α=(5+5)/5=2.

Thus, the JD Data Growth Rate, which is a parameter for calculating a path metric for Joint Detection, is a parameter determined by the number of quantization bits and UL MCS. After determining these parameters in advance, the originator stores the JD Data Growth Rates calculated by the above Formula (4) in the JD Path Discovery Request Frame and transmits them.

Note that, although description is given based on the metric calculation formula used in IEEE802.11s, the present technology is not particularly limited thereto, and a metric may be calculated from a received signal strength indication (RSSI), a signal-to-noise-ratio (SNR), and the like as long as at least a JD Growth Rate is used during path searching for Joint Detection. In addition, instead of the JD Data Growth Rate, the parameters used in Formula (4) may be stored in a frame, and a JD Data Growth Rate may be calculated when a path metric value is calculated.

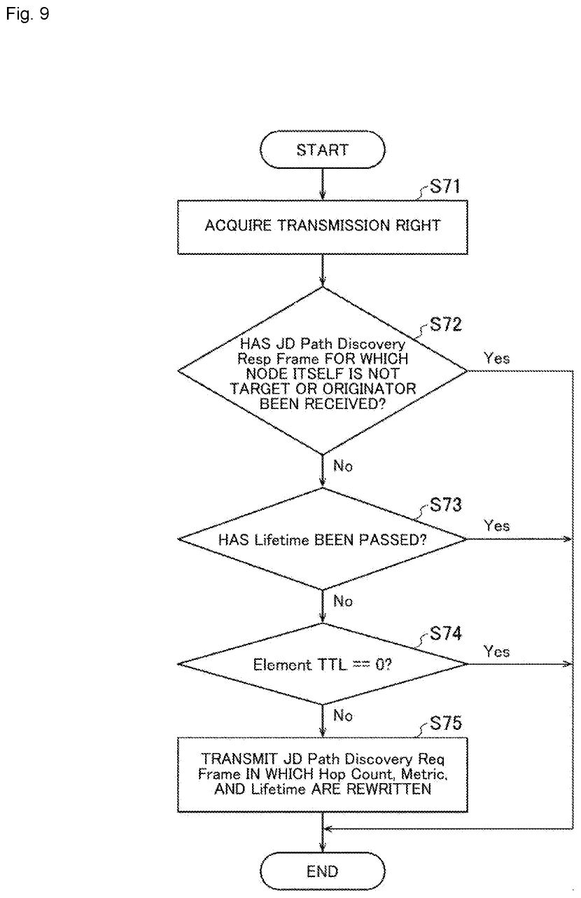

Next, a flow of processing at the time of transmitting a JD Path Discovery Request Frame will be described with reference to a flowchart of FIG. 9.

When each node receives a JD Path Discovery Request Frame for which the node itself is not a target or an originator (No in S72), Lifetime in the frame has not yet passed (S73 No), and Element TTL is not zero (No in S74) at the time of acquiring a transmission right (S71), the processing of step S75 is performed. That is, each node rewrites information such as Hop Count, Metric, and Element TTL in the acquired Detector Info and performs broadcast transmission of the JD Path Discovery Request Frame (S75).

In a case where any one of the above conditions is not satisfied (Yes in S72, Yes in S73, or Yes in S74), each node does not transmit the JD Path Discovery Request Frame at the time of acquiring the transmission right. Note that the timing of acquisition of the transmission right may be a timing when its own backoff is terminated or a timing when transmission is permitted by another communication device.

(Example of Route Table)

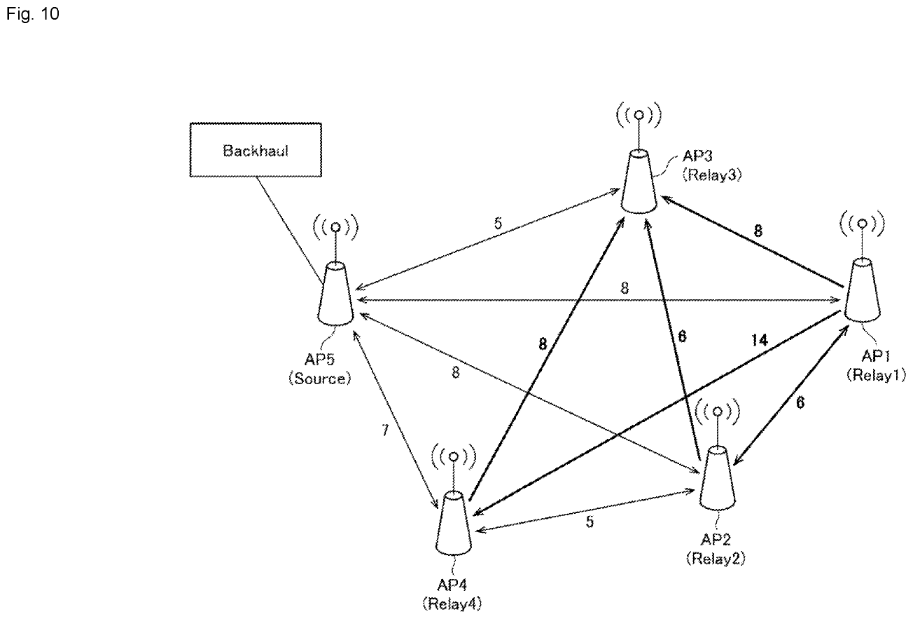

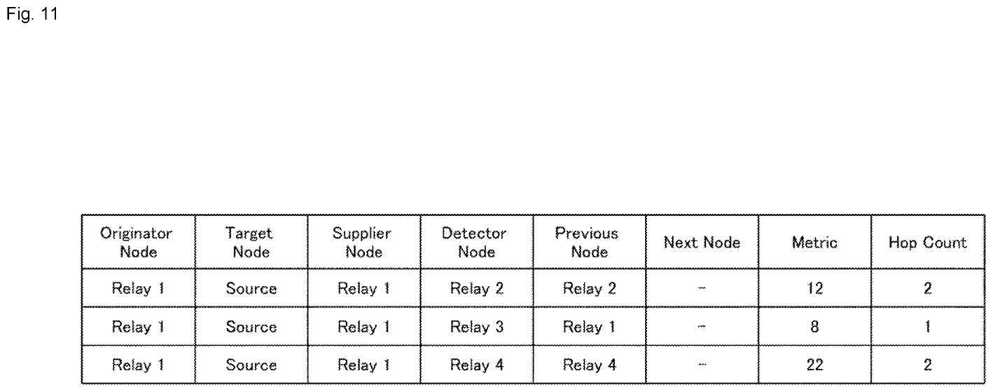

Here, an example of a route table at the time of transmitting and receiving a JD Path Discovery Request Frame will be described with reference to FIGS. 10 and 11. FIG. 10 is a diagram illustrating a first example of links between nodes. FIG. 11 is a diagram illustrating an example of a route table of a relay node 3 (Relay 3) in a case where the links between the nodes illustrated in FIG. 10 are formed.

As illustrated in FIG. 10, it is assumed that the relay node 1 (Relay 1) is an originator, a source node (Source) is a target, and the transmission of a JD Path Discovery Request Frame is started from the relay node 1 (Relay 1). In FIG. 10, a link metric value is described on each link, and the link metric value calculated using a formula that is different from that in the existing method as described above is described on the assumption that Pre-demodulated Data is transmitted for all links at the first hop from the relay node 1 (Relay 1) (that is, a destination is a detector candidate node).

Here, for the sake of simplicity, it is assumed that the link metric is twice a link metric in a normal case when Pre-demodulated Data is transmitted. Note that the same assumptions are made in all cases unless otherwise specified.

In the existing method, the relay node 3 (Relay 3) stores only the shortest path from the relay node 1 (Relay 1) (that is, “Relay 1→Relay 3”) for a path from the relay node 1 (Relay 1) to the source node (Source), and discards frames having larger metric values. On the other hand, in the method to which the present technology is applied, a path having the minimum metric is continuously stored in the route table for each detector candidate node. For example, as illustrated in FIG. 11, when the relay node 3 (Relay 3) itself is a detector candidate node, the shortest path passing through itself is “Relay 1→Relay 3”, a Previous Node is Relay 1, a metric value is 8 (twice a metric value of 4 in a normal case), and the number of hops is 1.

On the other hand, in a case where a detector candidate node is the relay node 2 (Relay 2), the relay node 3 (Relay 3) has the shortest path passing through itself as “Relay 1→Relay 2→Relay 3”, a Previous Node is Relay 2, a metric value is 12 (3*2+6), and the number of hops is 2. In addition, management is performed in the same manner when a detector candidate node is the relay node 4 (Relay 4).

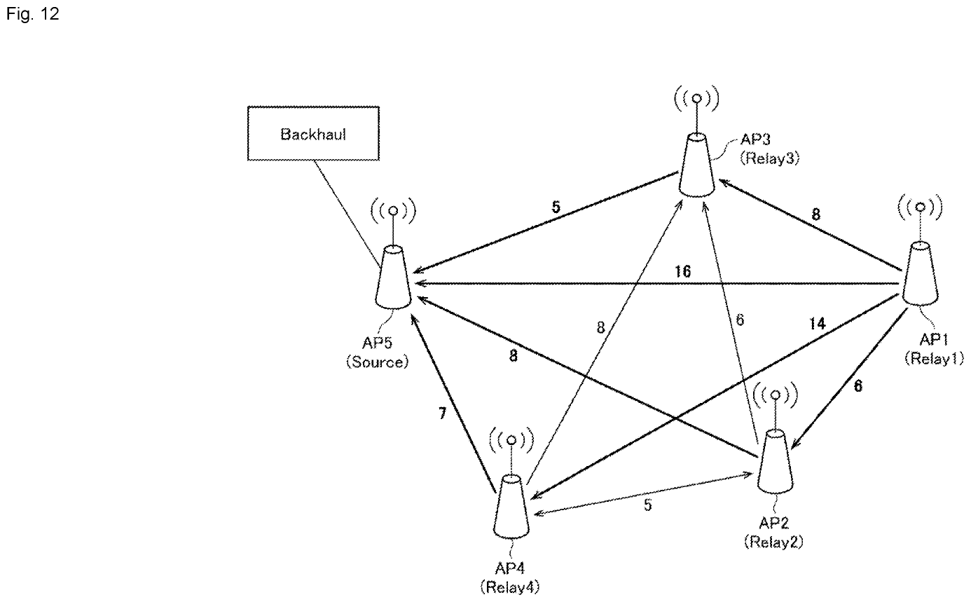

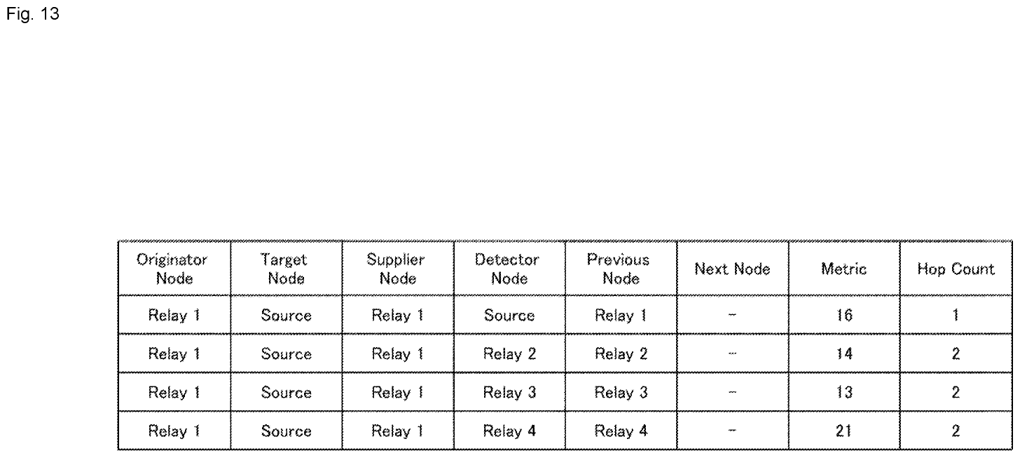

Next, an example of a route table of a source node (Source) at the time of receiving a JD Path Discovery Request Frame will be described with reference to FIGS. 12 and 13. FIG. 12 is a diagram illustrating a second example of links between nodes. FIG. 13 is a diagram illustrating an example of a route table of a source node (Source) when the links between the nodes illustrated in FIG. 12 are formed.

Similarly to the relay node 3 (Relay 3) described above, the source node (Source) stores a minimum metric, a Previous Node, and a Hop Count for each detector candidate node in the received JD Path Discovery Request Frame in a route table.

For example, in a case where the source node (Source) itself is a detector candidate node, a shortest path passing through the source node itself is “Relay 1→Source”, a Previous Node is Relay 1, a metric value is 16 (8*2), and the number of hops is 1.

On the other hand, in a case where the detector candidate node is the relay node 3 (Relay 3), the source node (Source) has the shortest path passing through the source node itself as “Relay1→Relay 3→Source”, a Previous Node is Relay 3, a metric value is 13 (4*2+5), and the number of hops is 2. In addition, management is performed in the same manner when detector candidate nodes are the relay node 2 (Relay 2) and the relay node 4 (Relay 4).

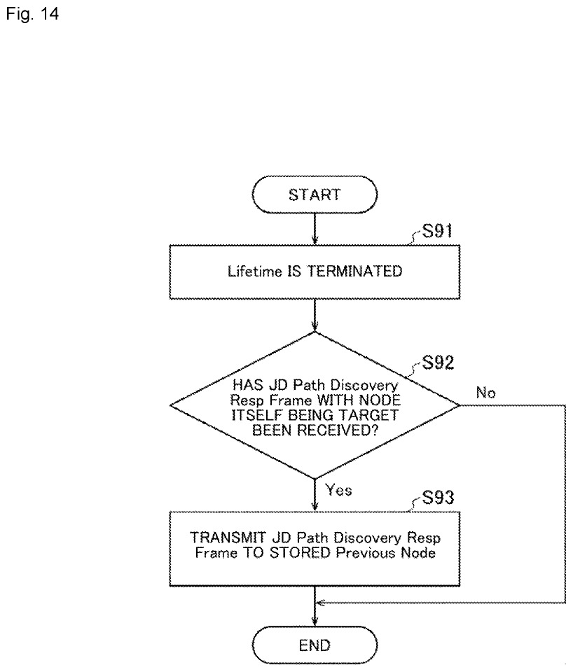

A flow of processing at the time of transmitting a JD Path Discovery Response Frame will be described with reference to a flowchart of FIG. 14.

When the Lifetime designated in a JD Path Discovery Request Frame is terminated (S91), and the node having received the frame is designated as a target in the frame (Yes in S92), the node transmits a JD Path Discovery Response Frame to the stored Previous Node (S93).

It is assumed that a notification is given using a Previous Node Address field in a JD Path Discovery Response Element as information indicating the destination of the JD Path Discovery Response Frame, but when there is only one piece of Detector Info, a destination may be designated by RA of a MAC header.

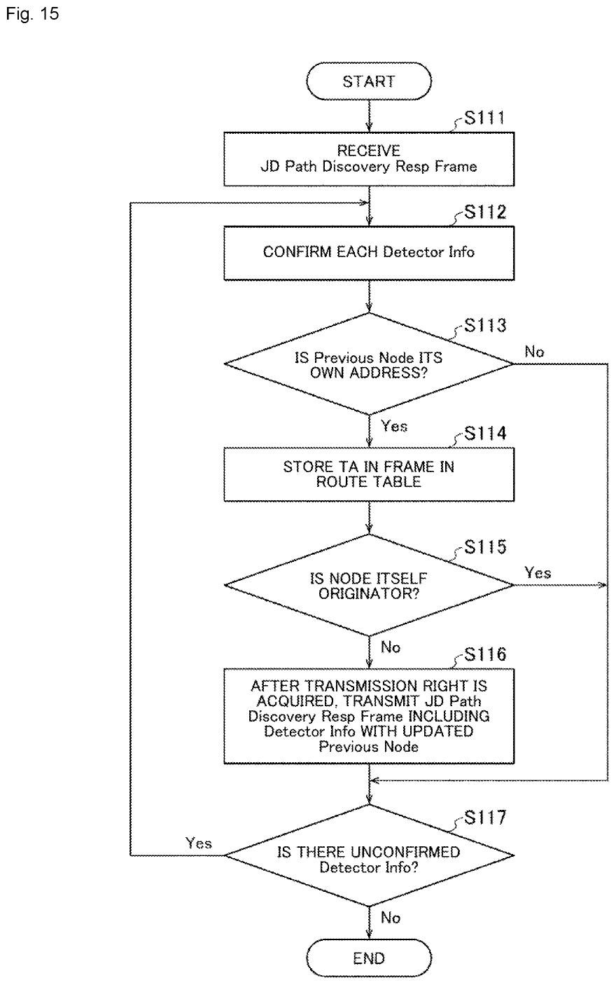

Next, a flow of processing at the time of receiving a JD Path Discovery Response Frame will be described with reference to a flowchart of FIG. 15.

When the node receives the JD Path Discovery Response Frame (S111), Detector Info in an Element of the frame is confirmed one by one (S112).

In a case where a Previous Node Address in the Detector Info indicates the address of the node itself (Yes in S113), the node is stored as a Next Node of a route table in which information of a transmission source address (TA) is managed in association with a Detector Address (S114).

Thereafter, in a case where the node itself is not an originator (No in S115), the node acquires the next transmission right and then transmits a JD Path Discovery Response Frame including Detector Info with an updated Previous Node Address field (S116).

Note that, in a case where the Previous Node Address does not indicate the address of the node itself (No in S113), or in a case where the node itself is an originator (Yes in S115), the processing for the confirmed Detector Info is terminated. In addition, when there is unconfirmed Detector Info (Yes in S117), the processing returns to step S112, and the processing performed so far is performed by the number of pieces of Detector Info.

(Example of Route Table)

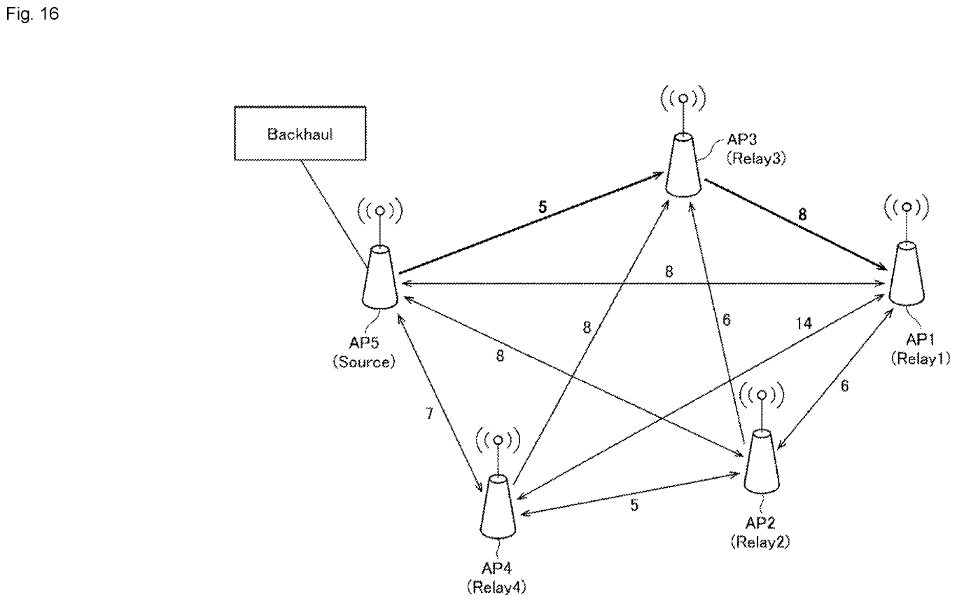

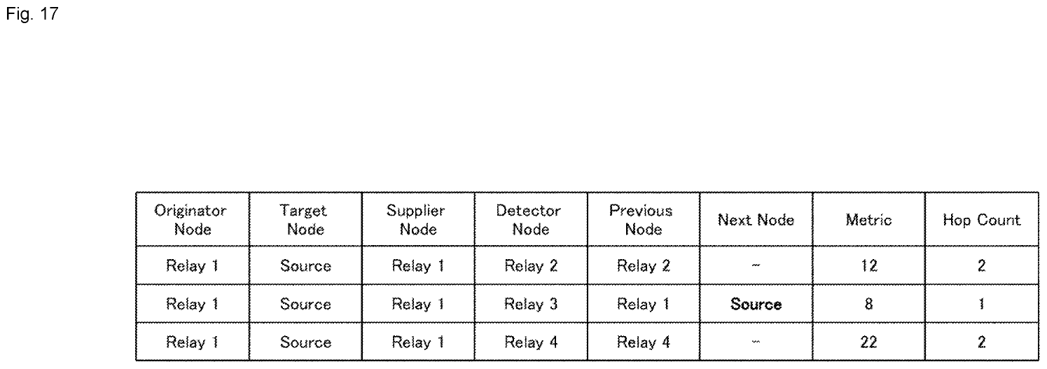

Here, an example of a route table at the time of receiving a JD Path Discovery Response Frame will be described with reference to FIGS. 16 and 17. FIG. 16 is a diagram illustrating a third example of links between nodes. FIG. 17 is a diagram illustrating an example of a route table of the relay node 3 (Relay 3) in a case where linking between nodes illustrated in FIG. 16 are formed.

As a result of confirming the Detector Info in the JD Path Discovery Response Frame one by one, the relay node 3 (Relay 3) recognizes that the node itself servers as a Previous Node in the frame transmitted from the source node (Source) only when the node itself serves as a detector candidate node.

Then, the relay node 3 (Relay 3) stores a Next Node in the route table as a Source in association with information managed as “Detector Node=Relay 3”. In this manner, when the relay node 3 (Relay 3) performs Joint Detection in which the relay node 1 (Relay 1) serves as a supplier, the node itself serves as a detector and transmits results obtained by performing demodulation processing and decoding processing to the source node (Source).

Note that, regarding information in which the detector is managed as another relay node in the route table, the relay node 3 (Relay 3) confirms that the node itself is not included in the shortest path to the source node (Source) when they are set as detectors. In this case, in the route table, the information that does not include the node itself may be immediately deleted, or may be stored for a certain period of time. In addition, a metric value may also be calculated in the JD Path Discovery Response Frame, and a metric value of a reverse link from the source node (Source) to the relay node 3 (Relay 3) may be managed together.

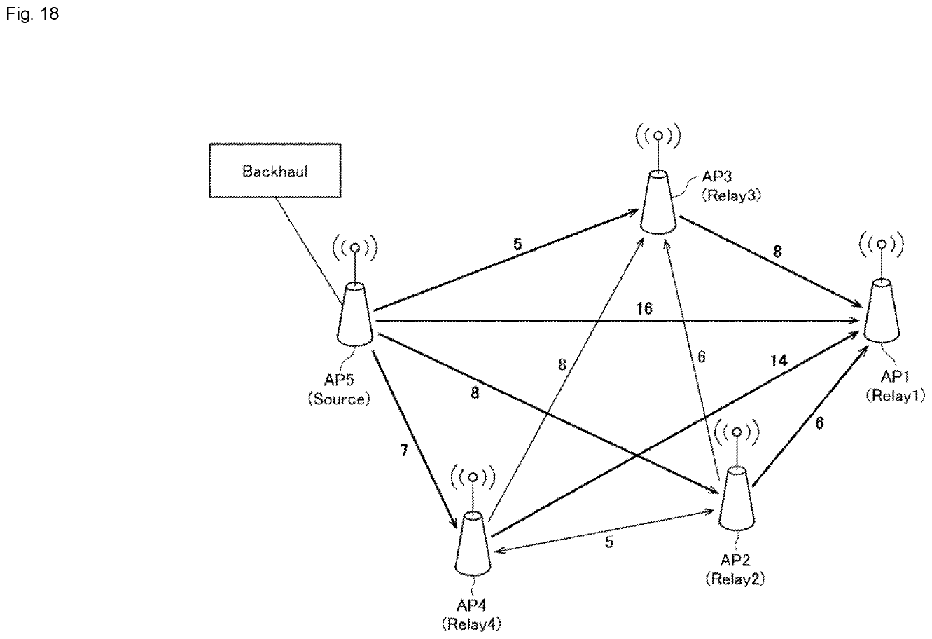

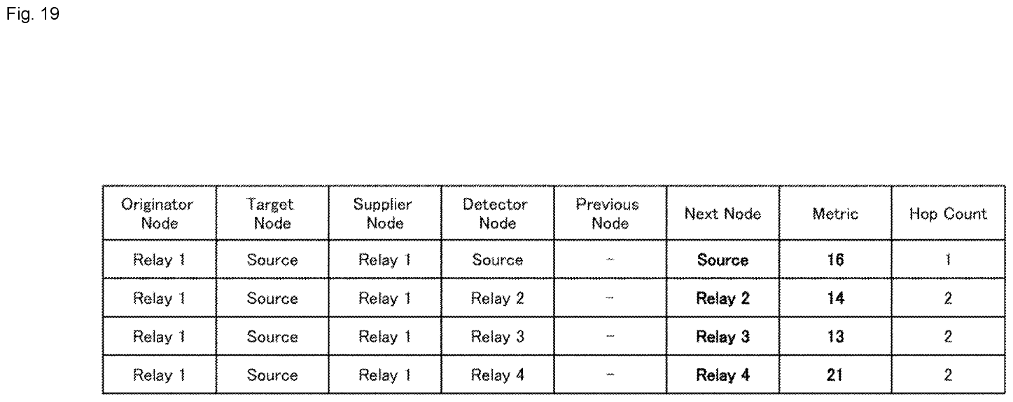

Next, an example of a route table of the relay node 1 (Relay 1) at the time of receiving a JD Path Discovery Response Frame will be described with reference to FIGS. 18 and 19. FIG. 18 is a diagram illustrating a fourth example of links between nodes. FIG. 19 is a diagram illustrating an example of the route table of the relay node 1 (Relay 1) when the links between the nodes illustrated in FIG. 18 are formed.

The relay node 1 (Relay 1), which is an originator, receives a JD Path Discovery Response Frame from each node and stores an optimum path and a metric value at the time of setting each of the nodes as a detector in the route table.

Specifically, in the relay node 1 (Relay 1), a Next Node being a Source and a metric value being 16 are stored in association with information managed as “Detector Node=Source”, and a Next Node being a Relay 2 and a metric value being 14 are stored in association with information managed as “Detector Node=Relay 2”. Further, in the relay node 1 (Relay 1), a Next Node being Relay 3 and a metric value being 13 are stored in association with information managed as “Detector Node=Relay 3”, and a Next Node being Relay 4 and a metric value being 21 are stored in association with information managed as “Detector Node=Relay 4”.

As will be described later, the relay node 1 (Relay 1) can select an optimum transmission route at the time of performing Joint Detection by using these pieces of information. In addition, a metric value may also be calculated in the JD Path Discovery Response Frame, and a metric value of a reverse link from the source node (Source) to the relay node 1 (Relay 1) may be managed together.

(S3: Joint Detection Phase)

Details of the Joint Detection Phase (S3 in FIG. 5) in the overall sequence diagram will be described. Here, a configuration example of a frame used in the Joint Detection Phase and a flowchart illustrating a flow of processing will be described.

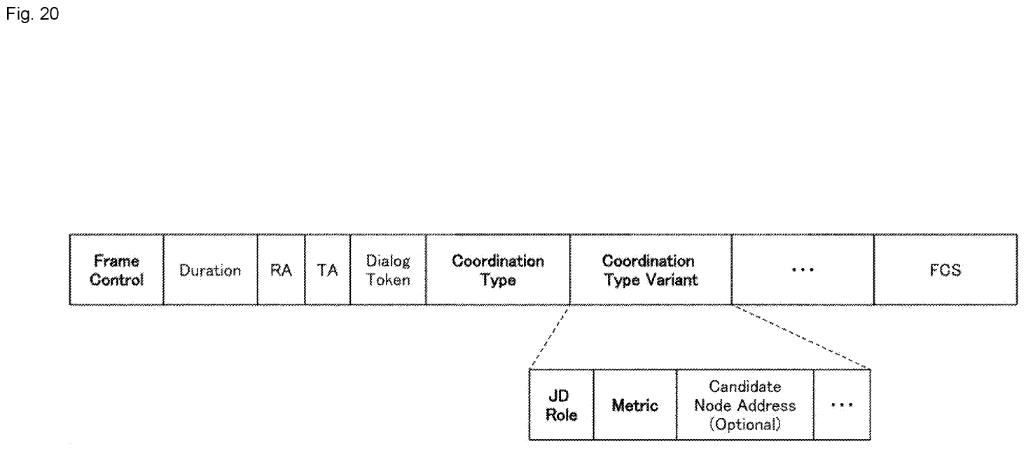

FIG. 20 is a diagram illustrating a configuration example of a JD Setup Frame.

The JD Setup Frame is constituted by Frame Control, Duration, RA, TA, Dialog Token, Coordination Type, Coordination Type Variant, and FCS. Here, a configuration based on an Action Frame of IEEE802.11-2016 is shown.

The Frame Control includes information indicating the type of frame. The Duration includes information indicating the length of the frame. The RA includes a transmission destination address. The TA includes a transmission source address. The Dialog Token includes information indicating a setup processing number.

The Coordination Type includes information for designating a coordination method. In the first embodiment, the execution of Joint Detection is described as the designation information. The Coordination Type Variant includes an information group specific to the coordination method designated in the Coordination Type field. In the first embodiment, information at the time of performing Joint Detection is included as the information group. In addition, the FCS is added as an error correction code. The Coordination Type Variant includes fields of JD Role, Metric, and Candidate Node Address.

The JD Role includes information indicating whether a transmission destination node is a detector or a supplier. Note that the JD Role may be set to “Unknown” and left to the determination of a request destination. The Metric includes a metric value in the role designated in the JD Role. The Metric can be set to a numeric value stored in its own route table. Note that the Metric may be set as information indicating “Unknown”.

The Candidate Node Address includes a coordination candidate node address of Joint Detection. The Candidate Node Address is an arbitrary field, and is used only when a coordination node and a JD Role cannot be determined by itself such as when a route table managed by a Joint Detection request source is not sufficient. Note that, in a case where a coordination node is designated, destination information is indicated by RA of a frame, and thus the field is not necessary. When the field is used, the RA can be a broadcast address or a multicast address. In addition, a broadcast address or a multicast address may be set in the field, and a specific candidate node may not be designated.

Note that the JD Setup Frame is not limited to the frame configuration illustrated in FIG. 20, and is only required to include at least information of the Coordination Type, the JD Role, and the Metric illustrated in the drawing. In addition, the frame is described assuming a MAC Frame, but may be transmitted as a TCP/IP Frame as long as the above-described information is described.

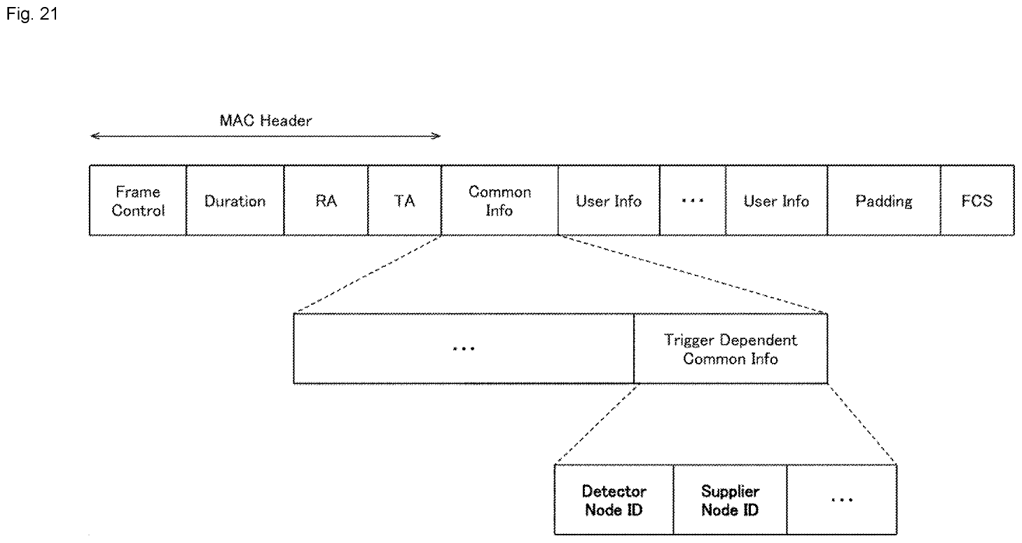

FIG. 21 is a diagram illustrating a configuration example of a JD UL Trigger. The JD UL Trigger is constituted by Frame Control, Duration, RA, TA, Common Info, User Info, Padding, and FCS. Here, a configuration based on a Trigger Frame of IEEE802.11ax is shown.

The Frame Control includes information indicating the type of frame. The Duration includes information indicating the length of the frame. The RA includes a transmission destination address. The TA includes a transmission source address.

The Common Info includes an information group which is common to the wireless terminal STA for UL transmission. The User Info includes an information group for each wireless terminal STA for UL transmission. The Padding is an addition bit provided for providing a preparation time for the wireless terminal STA to perform UL transmission. The FCS is an error correction code.

The Common Info includes Trigger Dependent Common Info. The Trigger Dependent Common Info includes a unique information group for each Trigger Type. In the first embodiment, an information group necessary when performing for Joint Detection is described in the unique information group. For example, the Trigger Dependent Common Info includes Detector Node ID and Supplier Node ID.

The Detector Node ID includes identification information of a node that plays a role of a detector. The identification information may be information by which MAC address, BSS Color, or other information can be identified. The Supplier Node ID includes identification information of a node that plays a role of a supplier. The identification information may be information by which MAC address, BSS Color, or other information capable of identifying each node.

Note that the JD UL Trigger is not limited to the frame configuration illustrated in FIG. 21, and may include at least information of the Detector Node ID and the Supplier Node ID illustrated in the drawing. In addition, the frame is described assuming a MAC Frame, but may be transmitted as a TCP/IP Frame as long as the above-described information is described.

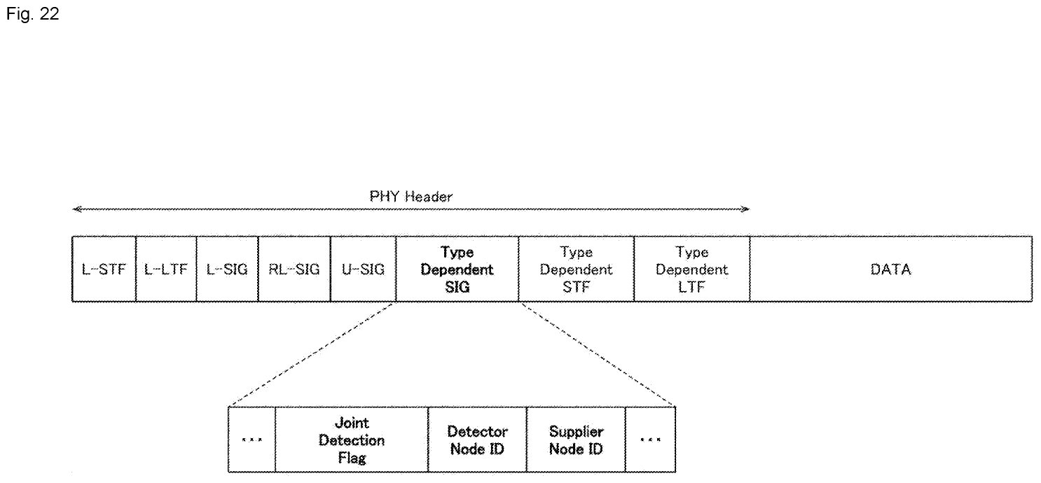

FIG. 22 is a diagram illustrating a configuration example of a JD UL Data Frame.

The JD UL Data Frame is constituted by L-STF, L-LTF, L-SIG, RL-SIG, U-SIG, Type Dependent SIG, Type Dependent STF, Type Dependent LTF, and DATA. Here, a configuration based on a PHY header under discussion in IEEE802.11be is shown.

The L-STF is an abbreviation for non-HT (High Throughput) Short Training field and is used for signal detection. The L-LTF is an abbreviation for non-HT Long Training field and is used for frequency synchronization. The L-SIG is an abbreviation for non-HT SIGNAL field and includes an information group (Length and the like) for non-HT STA.

The RL-SIG is an abbreviation for Reverse non-HT SIGNAL field and is used to represent a data frame after HT. The U-SIG is an abbreviation for Universal SIGNAL field and is a field including an information group with a common standard since IEEE802.11be.

The Type Dependent SIG is an abbreviation for Type Dependent SIGNAL field and is a field including an information group which is different for each standard since IEEE802.11be. For example, in the case of IEEE802.11be, “EHT-SIG” is designated. The Type Dependent STF is an abbreviation for Type Dependent Short Training field and is used for synchronizing a wideband signal which is different for each standard since IEEE802.11be. The Type Dependent LTF is an abbreviation for Type Dependent Long Training field and is used for channel estimation of a MIMO signal which is different for each standard since IEEE802.11be. The DATA is a data portion following the PHY header.

The Type Dependent SIG includes fields of Joint Detection Flag, Detector Node ID, and Supplier Node ID.

The Joint Detection Flag is a flag indicating a UL signal for Joint Detection. The Detector Node ID includes identification information of a node that plays a role of a detector. The Supplier Node ID includes identification information of a node that plays a role of a supplier. Information in the JD UL Trigger is described in the identification information.

Note that the JD UL Data Frame is not limited to the frame configuration illustrated in FIG. 22, and it is only required that at least information of the Joint Detection Flag, the Detector Node ID, and the Supplier Node ID illustrated in the drawing is included in the PHY header.

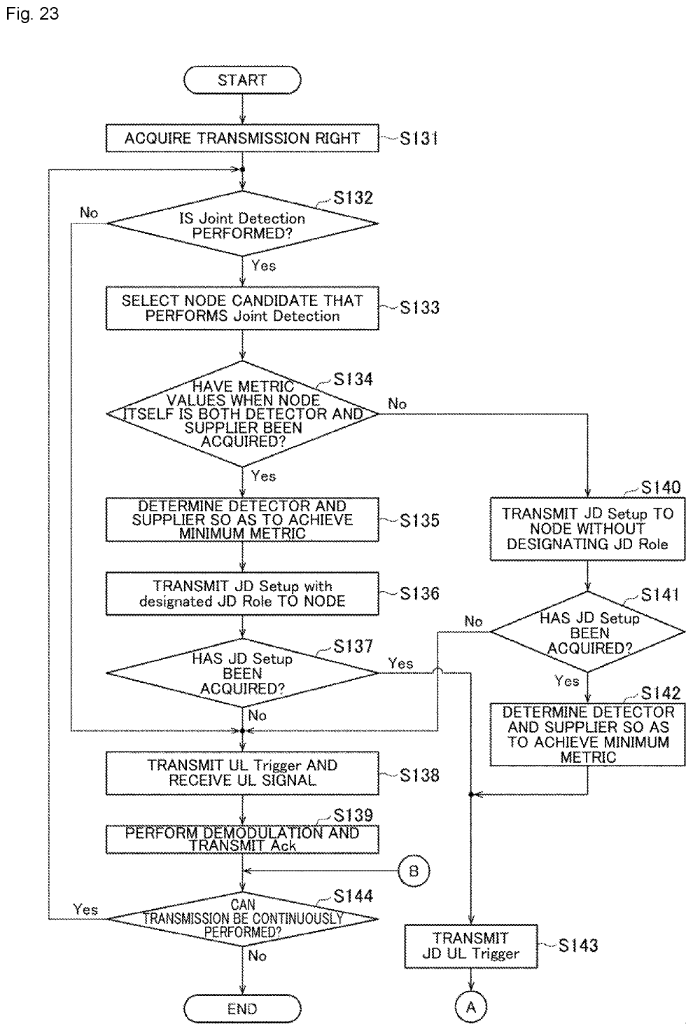

Next, a flow of processing in a sharing node will be described with reference to a flowchart of FIG. 23. Here, a node that has acquired a transmission right is referred to as a sharing node.

First, in a case where the sharing node acquires a transmission right (S131) and then performs Joint Detection (Yes in S132), the sharing node selects a coordination candidate node (S133). Regarding the selection of the coordination candidate node, a sharing node is determined on the basis of a positional relationship of the wireless terminal STA that induces UL transmission (that is, a link metric between the wireless terminal STA and each node) and a metric value (acquired in a Path Discovery Phase) to a source node in a mesh network. Note that, when the coordination candidate node is selected, a propagation loss with respect to the wireless terminal STA that induces UL transmission may be taken into consideration.

Next, a role in Joint Detection is determined. In the previously selected coordination candidate node, when the route table managed by itself stores both a metric value when the coordination candidate node is a detector and the node is a supplier, and a metric value when the coordination candidate node is a supplier and the node is a detector (Yes in S134), the processing proceeds to step S135. Then, a detector and a supplier are determined so as to achieve a minimum metric (S135), and the JD Setup Frame with a designated JD Role is transmitted to the node (S136).

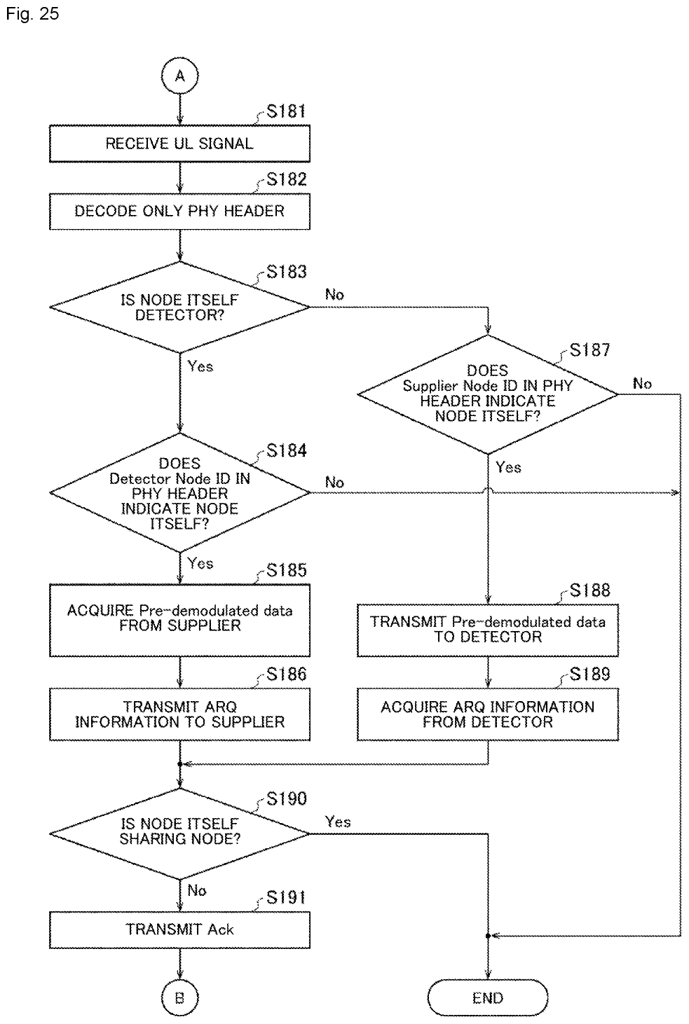

In a case where a response of the JD Setup Frame is received from the node (Yes in S137), a JD UL Trigger is transmitted to the wireless terminal STA (S143), and a UL signal is received. The subsequent processing will be described with reference to FIG. 25. Note that when the wireless terminal STA has received the JD UL Trigger, the wireless terminal STA can transmit a UL signal (for example, the JD UL Data Frame in FIG. 22) including a flag (for example, the Joint Detection Flag in FIG. 22) indicating the execution of coordination processing and a PHY header in which node identification information (for example, the Detector Node ID and the Supplier Node ID in FIG. 22) according to the role of processing at the time of performing the coordination processing is set, based on information included in the JD UL Trigger.

On the other hand, in a case where the route table stores only a metric value when the coordination candidate node itself is a supplier and the node is a detector (No in S134), a JD Setup Frame is transmitted to the node without designating a JD Role (S140). Then, a response of the JD Setup Frame has been received (Yes in S141), a detector and a supplier are determined with reference to a metric value in the response signal (S142), and a JD UL Trigger is transmitted to the wireless terminal STA (S143). The subsequent processing will be described with reference to FIG. 25.

In addition, when Joint Detection is not performed (No in S132), or when a JD Setup Frame cannot be acquired from the node for a certain period of time (No in S137, No in S141), the sharing node transmits a UL Trigger to the wireless terminal STA as in the existing method (S138), receives a UL signal, and then returns Ack (S139). Thereafter, when a transmittable period remains (Yes in S144), this processing can be started again. Further, in this case, the sharing node itself may transmit a DL (Downlink) signal to the wireless terminal STA.

Here, the number of coordination candidate nodes is not limited to one, and a plurality of coordination candidate nodes may be provided. In this case, a plurality of Node Addresses are stored in the Candidate Node Address in the JD Setup Frame of FIG. 20. The returned JD Setup Frame may be transmitted for each node in a time-division manner, or may be scheduled and transmitted using orthogonal frequency division multiple access (OFDMA) or the like.

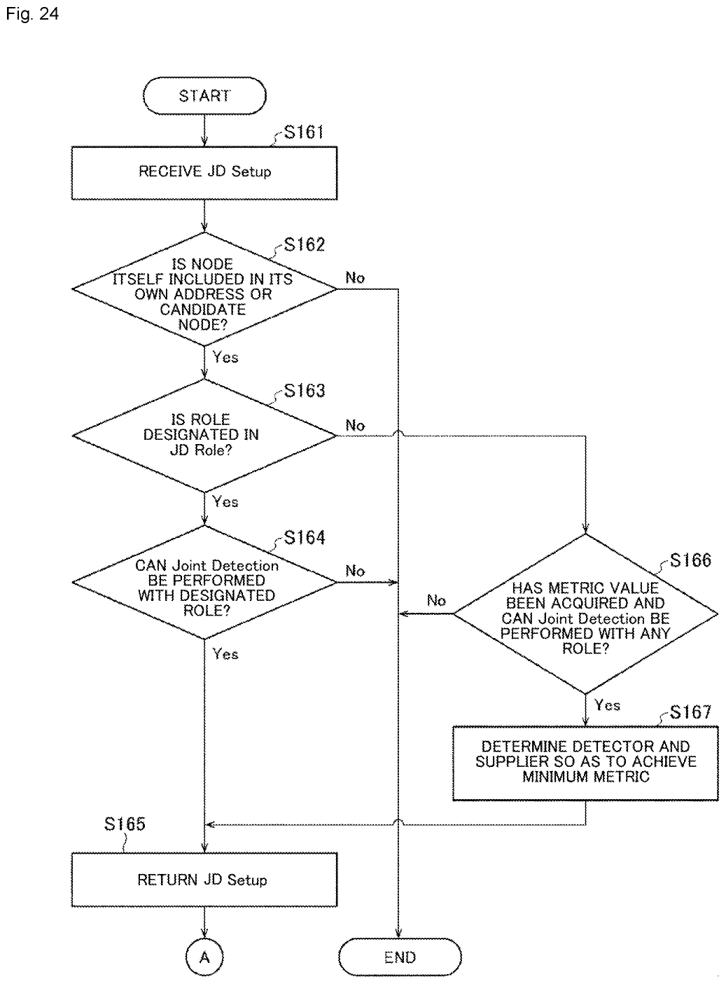

Next, a flow of processing in a shared node will be described with reference to a flowchart of FIG. 24. Here, a node that acquires a JD Setup Frame from a sharing node and performs Joint Detection is referred to as a shared node.

When the shared node acquires a JD Setup Frame (S161), the shared node confirms whether RA is its own address or whether an identifier indicating the shared node itself is stored in a Candidate Node Address in a Coordination Type Variant field (S162). When either of the two cases applies (Yes of S162), the processing proceeds to the next processing, and when but neither of the two cases applies (No of S162), the processing is terminated as it is.

Next, the shared node confirms whether a role is designated in a JD Role in the Coordination Type Variant field (S163). When a role is designated in the JD Role (Yes in S163), and Joint Detection can be performed with the designated role (Yes in S164), a JD Setup Frame is returned to the sharing node (S165).

In addition, when Joint Detection cannot be performed with the designated role (No in S164), the processing is terminated as it is. Note that, whether Joint Detection can be performed may be determined on the basis of Capability information, or may be independently determined based on information on the basis of information its own performance.

On the other hand, in a case where no role is designated in the JD Role (No in S163), the shared node determines a role. That is, in a case where a metric value when the shared node itself is a supplier and the sharing node is a detector has been acquired in its own route table, and Joint Detection can be performed (Yes in S166), a role is determined such that the metric value is the smallest (S167). In addition, the shared node determines a role and then returns a JD Setup Frame including the determined role information of the sharing node to the sharing node (S165).

In addition, when the shared node does not store the corresponding metric value, or when Joint Detection cannot be performed (No in S166), the processing is terminated as it is.

After returning the JD Setup Frame in the processing of step S165, the transmission of a JD UL Trigger from the sharing node is waited for, and a UL signal is received. The subsequent processing will be described with reference to FIG. 25.

Next, a flow of processing at the time of performing Joint Detection will be described with reference to a flowchart of FIG. 25. Here, after the sharing node transmits a JD UL Trigger (S143 in FIG. 23, S165 in FIG. 24), a flowchart which is common to both the sharing node and the shared node is obtained.

When each of the nodes receives a UL signal (S181), first, the node decodes only a PHY header and confirms information (S182). In a case where the node itself is a detector and a Detector Node ID in the PHY header indicates the node itself (Yes in S183, Yes in S184), the processing proceeds to step S185.

Then, the node as a detector waits for processing in a PHY layer until Pre-demodulated Data is transmitted from the supplier, and starts demodulation processing and decoding processing by Joint Detection at a point in time when the Pre-demodulated Data is acquired (S185). Thereafter, the node as a detector transmits automatic repeat-request (ARQ) related information of UL signal data to the supplier (S186). Further, in a case where the Detector Node ID in the PHY header does not indicate the node itself (No in S184), the processing is terminated as it is.

On the other hand, in a case where the node itself is a supplier and a Supplier Node ID in the PHY header indicates the node itself (No in S183, Yes in S187), the processing proceeds to step S188. Then, the node as a supplier transmits a received signal to a detector in the form of Pre-demodulated Data (S188). Thereafter, the node as a supplier acquires ARQ information from the detector (S189). The Pre-demodulated Data is transmitted in a quantized form. Communication between nodes may be transmitted at a timing when a transmission right is acquired or at a scheduled timing. Further, in a case where the Supplier Node ID in the PHY header does not indicate the node itself (No in S187), the processing is terminated as it is.

When the processing of step S186 or S189 is terminated, the processing proceeds to step S190. Finally, only when the node is a shared node, the node transmits Ack to the wireless terminal STA based on the ARQ information (No in S190, S191), and then returns to the divergence of step S144 in FIG. 23. Note that, depending on the result of Joint Detection, there may be a wireless terminal STA to which Ack is not transmitted.

### Effects

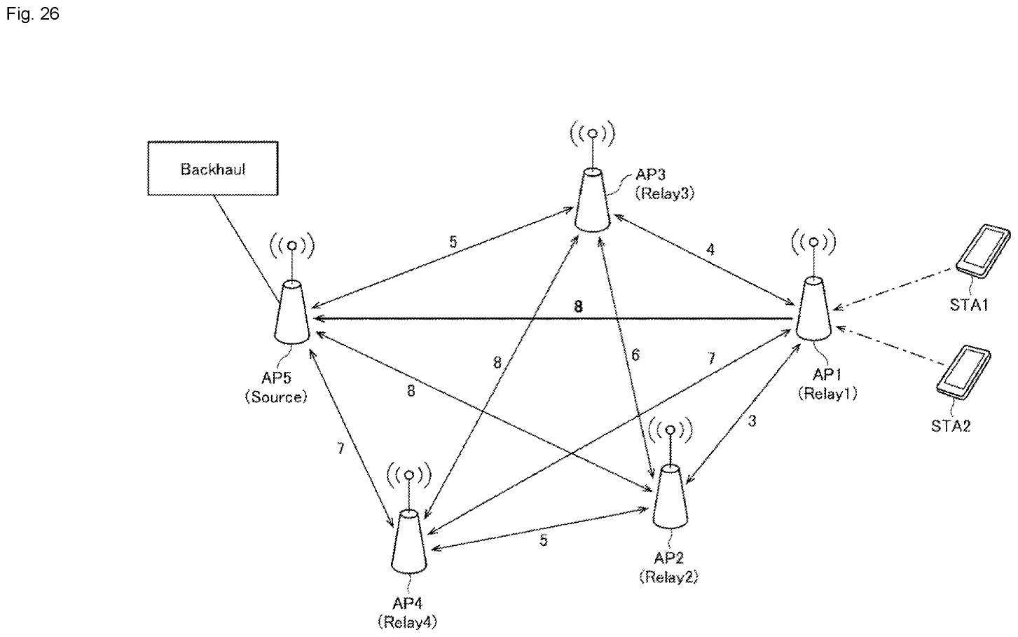

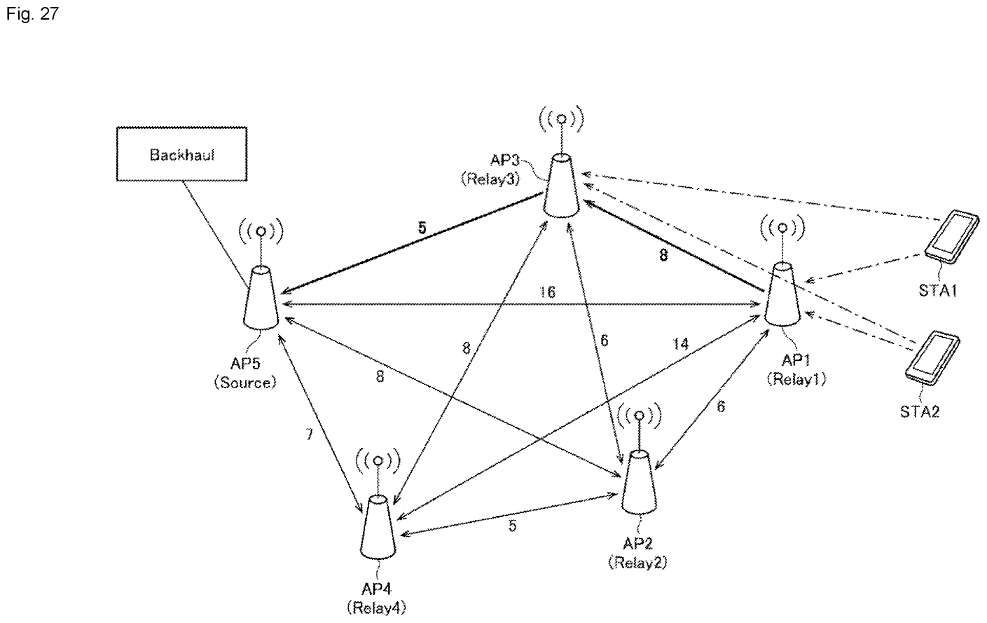

Finally, the effect of performing Joint Detection in the first embodiment will be described with reference to FIGS. 26 and 27.

Here, for comparison, FIG. 26 illustrates an example of links between nodes when normal data transmission is performed, and FIG. 27 illustrates an example of links between nodes when Joint Detection to which the present technology is applied is performed. In addition, here, description is given of operations at the time of performing Joint Detection in which the relay node 1 (Relay 1) serves as a sharing node in the route table stored by the relay node 1 (Relay 1) described above in FIGS. 18 and 19.

In a transmission route when the normal data transmission in FIG. 26 is performed, a route of “Relay 1→Source” with the smallest metric value is selected. This transmission route is determined by the existing Path Discovery method.

On the other hand, in FIG. 27, when the Joint Detection in the first embodiment is performed, the number of link metric values from a supplier to a detector is larger than in the existing method, and the shortest route is different. In this case, it can be understood that a route of “Relay 1→Relay 3→Source” with the relay node 1 (Relay 1) as a supplier and the relay node 3 (Relay 3) as a detector is a transmission route with the smallest metric value (13).

Although not mentioned in particular, regarding the roles of the relay node 1 (Relay 1) and the relay node 3 (Relay 3), it is only required that both a Path Discovery Phase in which the relay node 1 (Relay 1) is set as an originator and a Path Discovery Phase in which the relay node 3 (Relay 3) is set as an originator are completed, and the relay node 1 (Relay 1) stores any metric value by applying the present technology.

Even when the relay node 1 (Relay 1) does not store shortest route information and a metric value when the relay node itself is set as a detector, the role of Joint Detection can be determined by a JD Setup Frame when the relay node 3 (Relay 3) is stored in a route table. In this case, the shortest route with the relay node 3 (Relay 3) as a supplier and the relay node 1 (Relay 1) as a detector is a route of “Relay 3→Relay 1→Source”, and a metric value is 16, and thus it can be understood that this route is better than the route of “Relay 1→Relay 3→Source” with the relay node 1 (Relay 1) as a supplier and the relay node 3 (Relay 3) as a detector.

Note that, depending on a positional relationship between the wireless terminals STA, a candidate for a coordination node may be limited. For example, in the case of the configuration of FIG. 27, when it is determined that the source node (Source) and the relay node 4 (Relay 4) are far from the wireless terminals STA1 and STA2 and the possibility of a UL signal being correctly acquired is low, the relay node 1 (Relay 1) may limit the relay node 2 (Relay 2) or the relay node 3 (Relay 3) to coordination candidate nodes and then determine the shortest transmission route and the role of Joint Detection.

As described above, in the first embodiment, the configuration and the processing when the UL transmission parameters are fixed in the mesh network have been described. In the communication device 10 that performs the above-described processing, the following processing is performed by at least one control unit of the control unit 100, the communication control unit 111, and the communication control unit 121.

That is, the communication device 10 (for example, the access point AP) exchanges information (information in each frame) used to determine a multi-hop transmission route with another communication device (for example, another access point AP) by using wireless communication, and performs control for determining an optimum transmission route on the basis of the amount of transmission data increased (a: JD Data Growth Rate) at the time of performing processing (performing Joint Detection) by a plurality of communication devices in cooperation.

In addition, when the optimum transmission route is determined, it is possible to use a transmission route when it is assumed that the communication device itself is a supplier and transmits data before demodulation (for example, Pre-demodulated Data) which has not been subjected to demodulation processing to another communication device (detector). Further, when the optimum transmission route is determined, it is possible to calculate (calculation by, for example, Formula (3) and Formula (4)) and use a metric value (for example, a metric value for JD) for coordination processing which is determined by quantization bits of the data before demodulation (for example, the number of quantization bits of Pre-demodulated Data) and first parameters including a modulation method and a coding rate (for example, MCS) of an uplink signal.

At this time, a frame requesting calculation of a metric value (for example, the JD Path Discovery Request Frame in FIG. 6) includes a value (for example, the JD Data Growth Rate in FIG. 6) corresponding to the first parameters, an address (for example, the Detector Address in FIG. 6) for each detector candidate node which is a candidate for a node on a side that acquires data before demodulation among the plurality of communication devices, and a metric value (for example, the Metric in FIG. 6). In addition, a frame (for example, the JD Path Discovery Response Frame in FIG. 7) that responds to the calculation of the metric value includes an address (for example, the Detector Address in FIG. 7) for each detector candidate node which is a candidate for a node on a side that acquires data before demodulation among the plurality of communication devices, a metric value (for example, the Metric in FIG. 7), and an address of the previous node (for example, the Previous Node Address in FIG. 7).

By adopting the configuration in the first embodiment, for example, the following effects can be expected. That is, in a multi-hop network environment where there are a plurality of nodes, it is possible to determine an optimum transmission route taking transmission of the Pre-demodulated Data at the time of performing Joint Detection into consideration, and the transmission route including the role of Joint Detection.

Further, in the first embodiment, since metric calculation taking the amount of data increased due to transmission of Pre-demodulated Data in Path Discovery in a mesh network into consideration is performed, and thus it is possible to determine an optimum transmission route including the role of Joint Detection at the time of performing Joint Detection.

### 2. Second Embodiment

In the first embodiment, the shortest route during Joint Detection is searched for by calculating a metric for Joint Detection during a Path Discovery Phase. However, as described above, an increase rate of information of Pre-demodulated Data changes depending on MCS of a UL signal, and thus a metric value will change frequently. Executing the Path Discovery Phase each time may lead to a decrease in wireless capacity due to an increase in overhead.

Thus, in a second embodiment, a method in which a shortest path and the role of Joint Detection can be determined without frequently performing a Path Discovery Phase by calculating a metric value during Joint Detection immediately before is disclosed. Hereinafter, only differences from the first embodiment will be described.

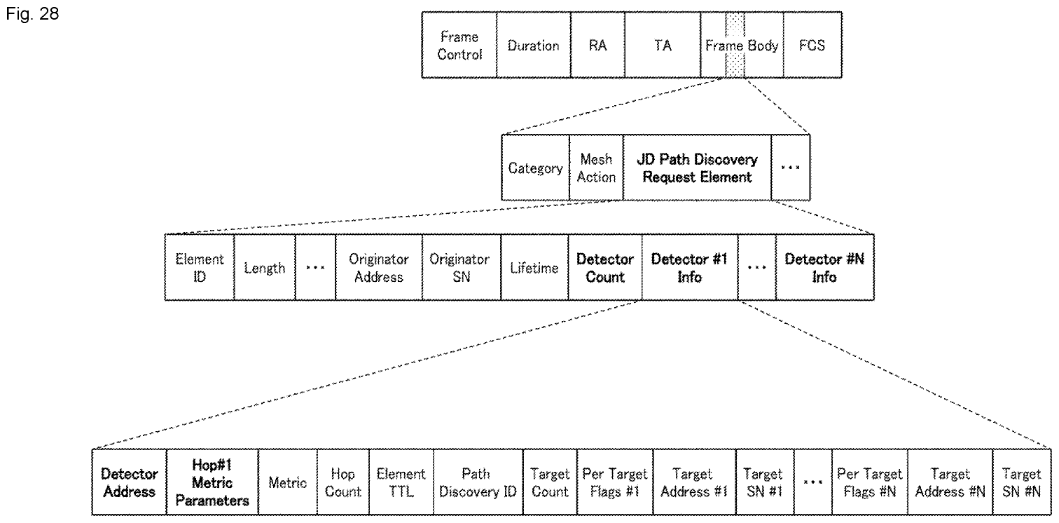

FIG. 28 is a diagram illustrating a configuration example of a JD Path Discovery Request Frame.

The JD Path Discovery Request Frame in the second embodiment is different from the JD Path Discovery Request Frame in the first embodiment (FIG. 6) in that JD Parameters are removed from a JD Path Discovery Request Element, and a field of Hop #1 Metric Parameters is newly added in Detector Info.

That is, Detector Info includes fields of Detector Address, Hop #1 Metric Parameters, Metric, Hop Count, Element TTL, Path Discovery ID, Target Count, Per Target Flags, Target Address, and Target SN.

The Hop #1 Metric Parameters include a parameter group necessary to calculate a metric for a first hop. Parameter types are not particularly limited. In the second embodiment, it is assumed that two of r and e_{f}, having variable elements among the parameters of Formula (2) which is a metric calculation formula are stored.

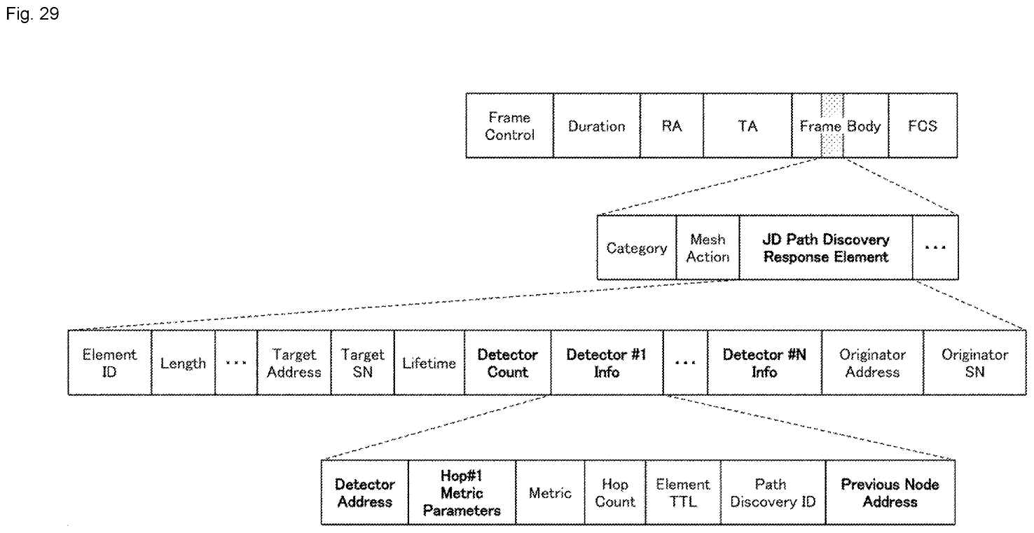

FIG. 29 is a diagram illustrating a configuration example of a JD Path Discovery Response Frame.

The JD Path Discovery Response Frame in the second embodiment is different from the JD Path Discovery Response Frame in the first embodiment (FIG. 7) in that a field of Hop #1 Metric Parameters is newly added in Detector Info.

That is, the Detector Info includes fields of Detector Address, Hop #1 Metric Parameters, Metric, Hop Count, Element TTL, Path Discovery ID, and Previous Node Address.

The Hop #1 Metric Parameters include a parameter group necessary to calculate a metric for a first hop. Parameter types are not particularly limited. In the second embodiment, it is assumed that two of r and of having variable elements among the parameters of Formula (2) which is a metric calculation formula are stored.

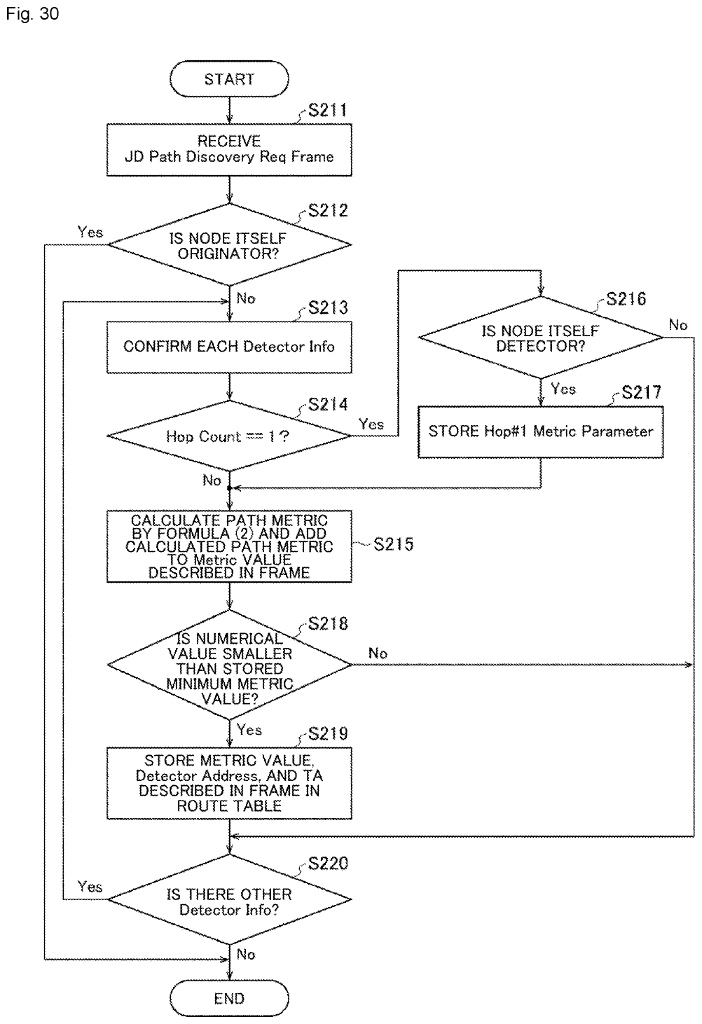

Next, a flow of processing at the time of receiving a JD Path Discovery Request Frame will be described with reference to a flowchart of FIG. 30.

Processing at the time of receiving a JD Path Discovery Request Frame in the second embodiment (S211 to S220 in FIG. 30) is particularly different from the processing at the time of receiving a JD Path Discovery Request Frame in the first embodiment (S41 to S50 in FIG. 8) in terms of processing contents of step S217 in FIG. 30 and step S47 in FIG. 8. That is, when Hop Count is “1” and the node itself is a detector candidate node (Yes in S214, Yes in S216) at the time of receiving the JD Path Discovery Request Frame, all pieces of information required for Hop #1 Metric Parameters in the frame are stored (S217), and a path metric is calculated using Formula (2) described above (S215). The Hop #1 Metric Parameters stored here are continuously stored in a JD Path Discovery Request Frame to be transmitted thereafter, and the same information is notified in the JD Path Discovery Response Frame.

(Example of Route Table)

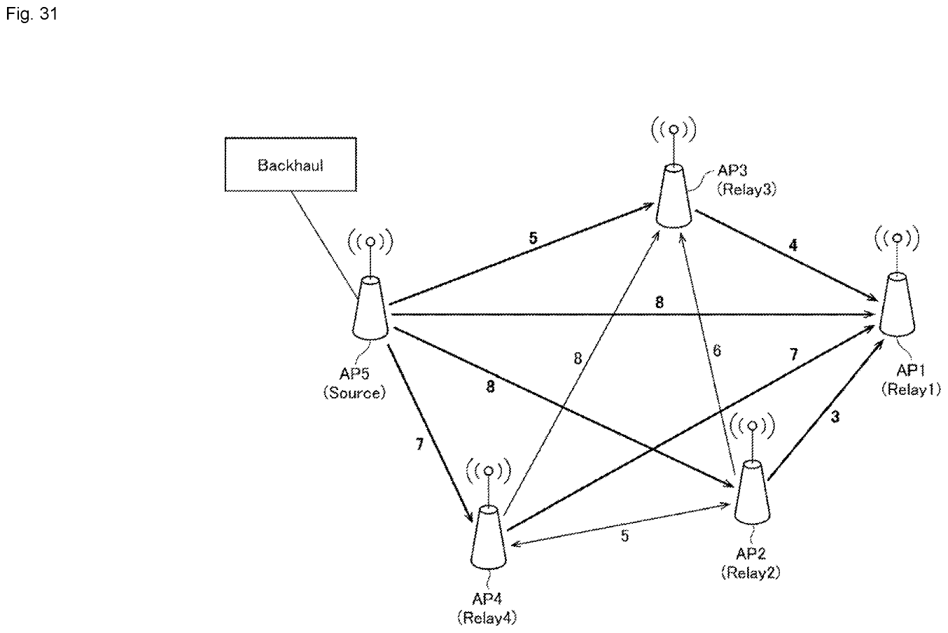

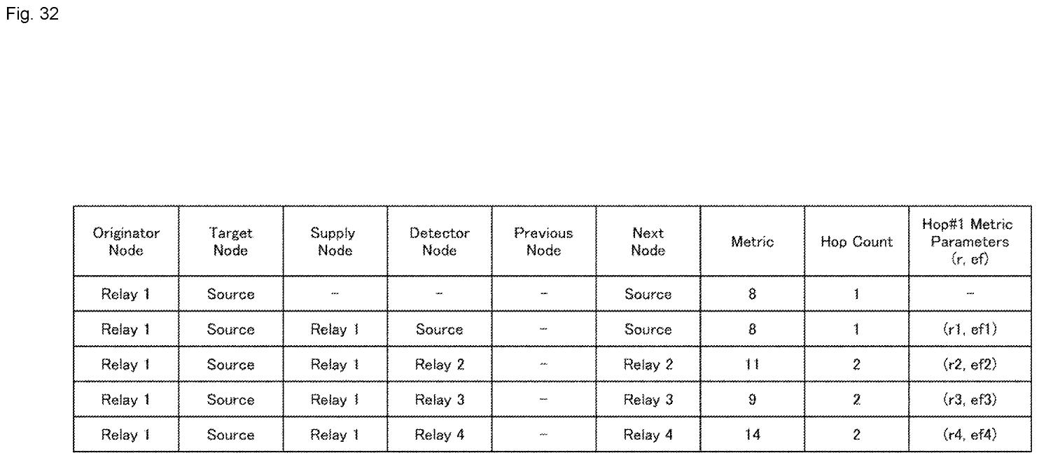

Here, an example of a route table at the time of receiving a JD Path Discovery Response Frame will be described with reference to FIGS. 31 and 32. FIG. 31 is a diagram illustrating a fifth example of links between nodes. FIG. 32 is a diagram illustrating an example of a route table of a relay node 1 (Relay 1) when the links between the nodes illustrated in FIG. 31 are formed.

The route table (FIG. 32) in the second embodiment is different from the route table (FIG. 11 and the like) in the first embodiment in that a metric value is the same as in the existing method, whereas Hop #1 Metric Parameters are newly stored and stored for each detector candidate node. Details will be described later, and the relay node 1 (Relay 1) can calculate a path for Joint Detection from the metric value and the Hop #1 Metric Parameters when performing Joint Detection and determine a shortest path and the role of Joint Detection.

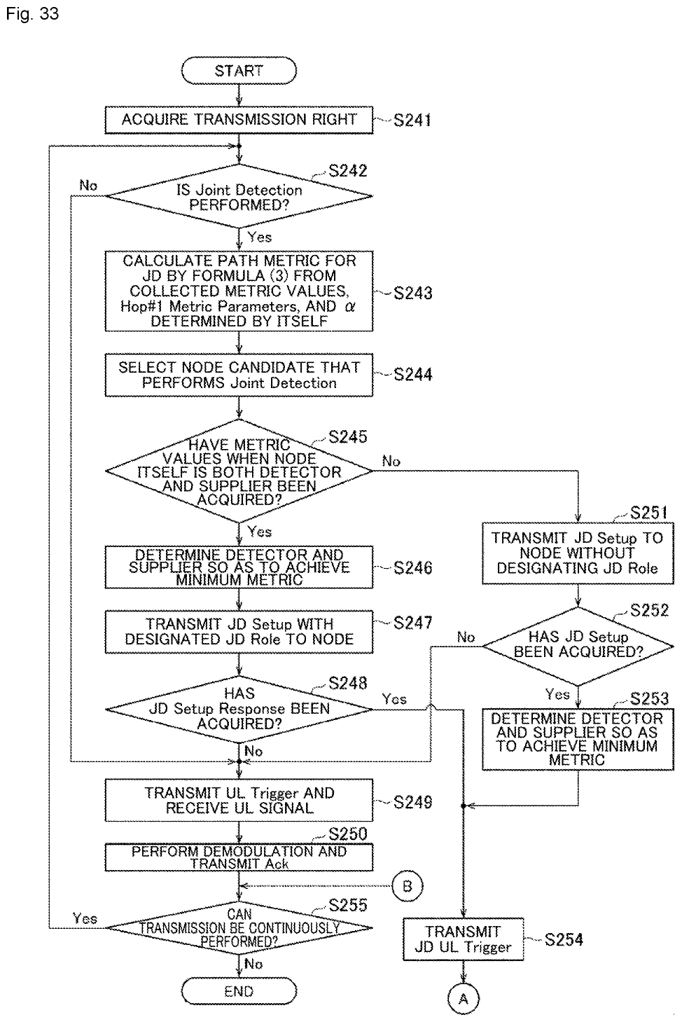

Next, a flow of processing in a sharing node will be described with reference to a flowchart of FIG. 33.

Processing of the sharing node in the second embodiment (S241 to S255 in FIG. 33) is particularly different from the processing of the sharing node in the first embodiment (S131 to S144 in FIG. 23) in that processing of step S243 in FIG. 33 is added.

That is, when Joint Detection is performed, a path metric for JD (JD Path Metric) is calculated for each detector candidate node (and for each supplier candidate node) from collected metric values, Hop #1 Metric Parameters, and a (JD Data Growth Rate) determined by itself (S243).

As a specific calculation method, the following Formula (5) is used. Note that the following “metric value for first hop” is calculated from Hop #1 Metric Parameters using Formula (2). In addition, “JD metric for first hop” is calculated from Hop #1 Metric Parameters and a (JD Data Growth Rate) using Formula (3).

JD Path Metric=(stored metric)−(metric value for first hop)+(JD metric for first hop) (5)

### Effects

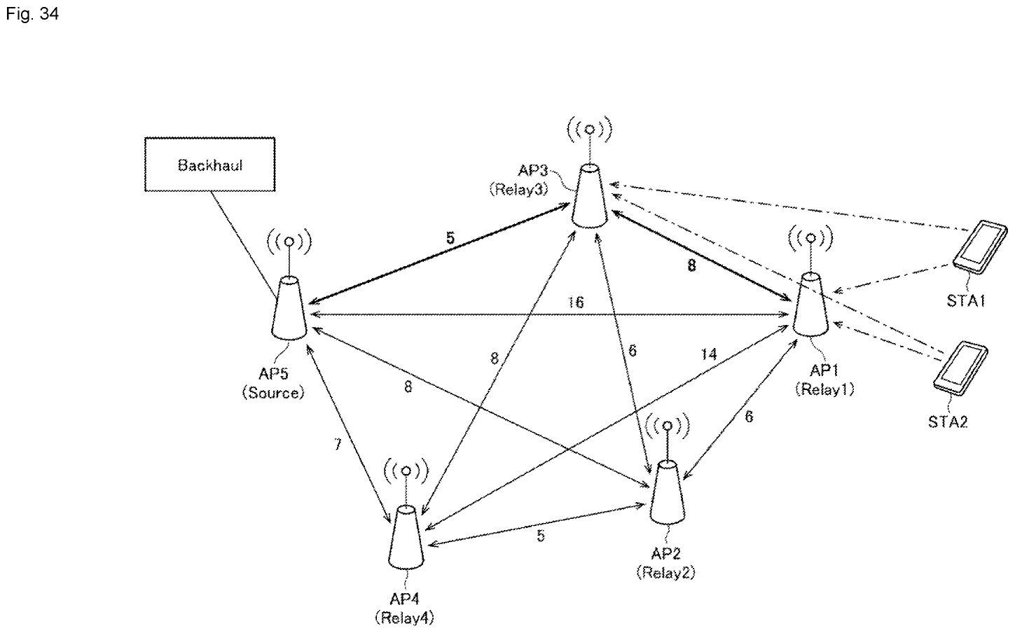

Finally, the effect of performing Joint Detection in the second embodiment will be described with reference to FIGS. 34 to 37.

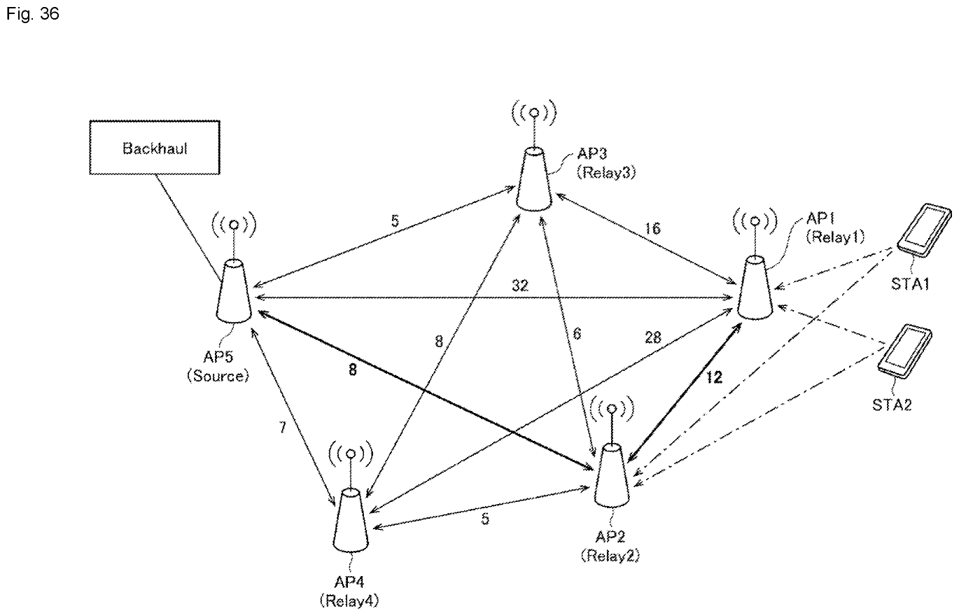

Both FIGS. 34 and 36 illustrate an example in which the relay node 1 (Relay 1) performs Joint Detection together with other nodes at the time of receiving UL signals from wireless terminals STA1 and STA2. FIG. 34 illustrates links between nodes when a metric is twice a matric in a normal case at the time of transmitting Pre-demodulated Data. FIG. 36 illustrates links between nodes when a metric is four times a metric in a normal case at the time of transmitting Pre-demodulated Data.

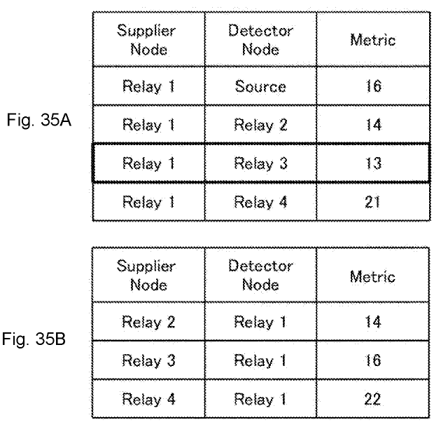

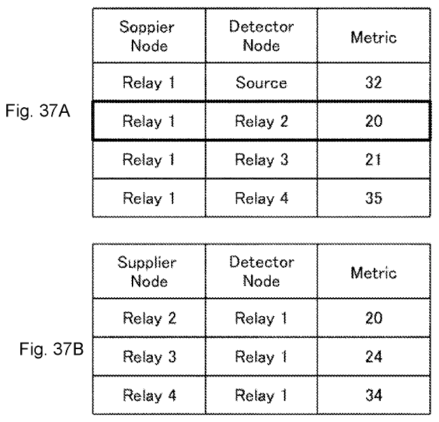

A route table in FIG. 35 corresponds to the links between the nodes illustrated in FIG. 34. A route table in FIG. 37 corresponds to the links between the nodes illustrated in FIG. 36. In FIGS. 35 and 37, an upper table (A in FIG. 35, A in FIG. 37) represents a route table when the node itself is a supplier (Supplier Node), and a lower table (B in FIG. 35, B in FIG. 37) represents a route table when the node itself is a detector (Detector Node). In these tables, all metric values are calculated using Formula (3) before the relay node 1 (Relay 1) induces a UL signal.

Note that the upper table can be calculated using information obtained within a Path Discovery Phase requested by the node itself (Relay 1). In addition, the lower table can be calculated using information obtained within a Path Discovery Phase requested by other nodes.

As can be understood from FIGS. 34 and 35, an optimum transmission route when a metric in the transmission of Pre-demodulated Data is twice a metric in a normal case is “Relay 1→Relay 3→Source”, and a metric value is 13. On the other hand, as can be understood from FIGS. 36 and 37, an optimum transmission route when a metric in the transmission of Pre-demodulated Data is four times a metric in a normal case is “Relay 1→Relay 2→Source”, and a metric value is 20.

In this manner, even when UL transmission parameters change, and a JD Growth Rate changes frequently, it is not necessary to perform a Path Discovery Phase again, and the relay node itself can determine an optimum transmission route and the role of Joint Detection.

As described above, in the second embodiment, a configuration and processing when UL transmission parameters fluctuate in a mesh network have been described. In a communication device 10 that performs the above-described processing, the following processing is performed by at least one control unit of a control unit 100, a communication control unit 111, and a communication control unit 121.

That is, the communication device 10 (for example, an access point AP) performs control for determining an optimum transmission route on the basis of a metric value calculated (for example, calculated by Formula (2)) without considering the amount of transmission data increased (a: JD Data Growth Rate), second parameters (for example, Hop #1 Metric Parameters in FIGS. 28 and 29) including values necessary to calculate a metric to a detector candidate node, which is a candidate for a node on a side that acquires data before demodulation (for example, Pre-demodulated Data) among a plurality of communication device, and values corresponding to first parameters (for example, the number of quantization bits of Pre-demodulated Data and MCS).

At this time, a frame requesting calculation of a metric value (for example, the JD Path Discovery Request Frame in FIG. 28) includes an address for each detector candidate node (for example, the Detector Address in FIG. 28), a metric value (for example, the Metric in FIG. 28), and values corresponding to second parameters (for example, Hop #1 Metric Parameters in FIG. 28). In addition, a frame responding to calculation of a metric value (for example, the JD Path Discovery Response Frame in FIG. 29) includes an address for each detector candidate node (for example, the Detector Address in FIG. 29), a metric value (for example, the Metric in FIG. 29), and values corresponding to second parameters (for example, the Hop #1 Metric Parameters in FIG. 29), and an address of the previous node (for example, the Previous Node Address in FIG. 29).

By adopting the configuration in the second embodiment, for example, the following effects can be expected. That is, in a multi-hop network environment where there are a plurality of nodes, it is possible to determine an optimum transmission route taking transmission of the Pre-demodulated Data at the time of performing Joint Detection into consideration, and the transmission route including the role of Joint Detection.

Further, in the second embodiment, a parameter information group for calculating a metric value of a link that is likely to transmit Pre-demodulated Data in Path Discovery in a mesh network is stored and returned to a request node, and thus the node can flexibly determine an optimum transmission route including the role of Joint Detection in consideration of the amount of data increased which may fluctuate depending on transmission parameters of UL transmission or the like at the time of performing Joint Detection.

### 3. Third Embodiment

In a third embodiment, a configuration and processing at the time of performing Joint Detection in a tree-type multi-hop network structure will be described.

(System Configuration Example)

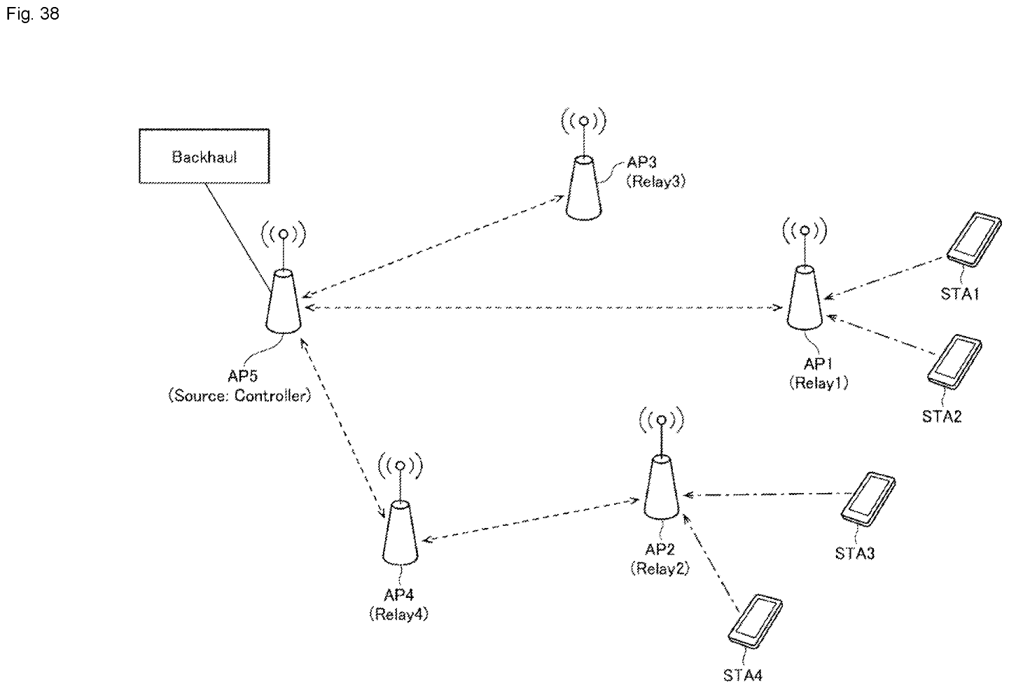

FIG. 38 is a diagram illustrating another configuration example of a wireless LAN system to which the present technology is applied.

In FIG. 38, the wireless LAN system includes five access points AP1 to AP5 and four wireless terminals STA1 to STA4. The access points AP constitute a tree-type network. In FIG. 38, access point AP5 is a source node, and the access points AP1 to AP4 are relay nodes 1 to 4 (Relay 1 to Relay 4). The wireless terminals STA1 and STA2 are under the control of the access point AP1, and the wireless terminals STA3 and STA4 are under the control of the access point AP2.

The wireless LAN system (FIG. 38) according to the third embodiment is different from the wireless LAN system (FIG. 1) according to the first embodiment in that a route between nodes (parent-child structure) is determined in advance. For this reason, in the wireless LAN system of FIG. 38, by measuring a metric value between links with the nodes, it is possible to determine which node is the most suitable for coordination when performing Joint Detection and further determine the role of Joint Detection.

(Overall Sequence Diagram)

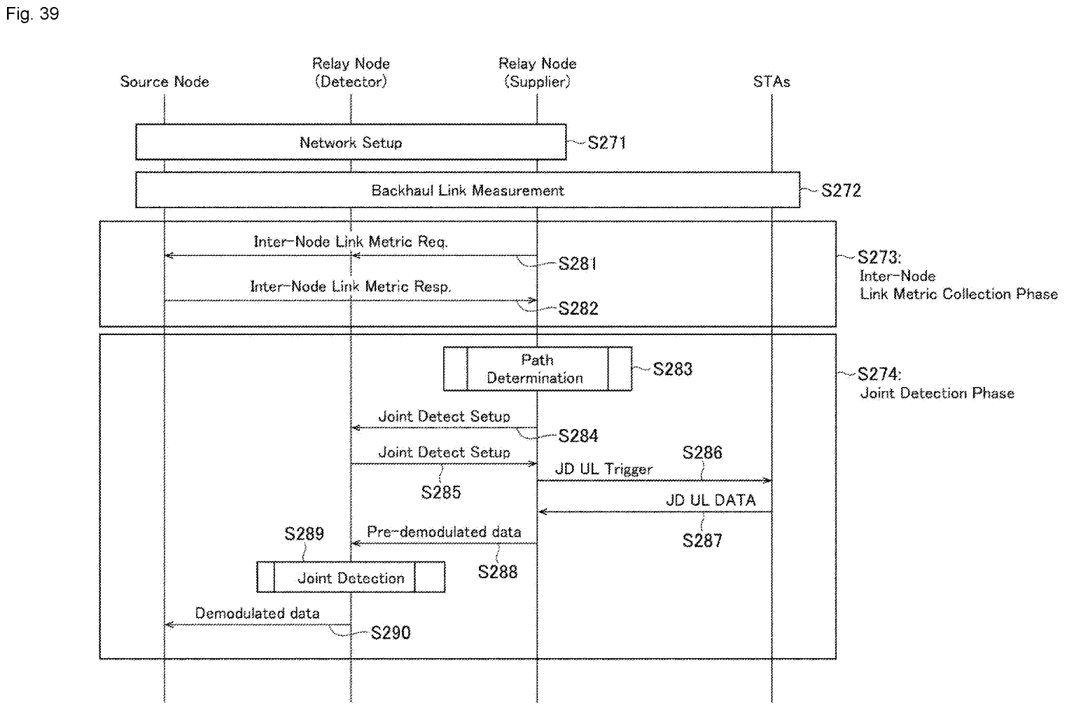

FIG. 39 is a sequence diagram illustrating exchanges between devices along a time axis according to the third embodiment.

The overall sequence diagram (FIG. 39) according to the third embodiment is different from the overall sequence diagram (FIG. 5) according to the first embodiment in that an Inter-Node Link Metric Collection Phase (S273 in FIG. 39) is performed instead of a Path Discovery Phase (S2 in FIG. 5).

That is, in the Inter-Node Link Metric Collection Phase (S273), a request source node transmits an Inter-Node Link Metric Request to the surrounding node (S281), so that the request source node receives a metric value measured from the surrounding node or a parameter group necessary to calculate the metric value as an Inter-Node Link Metric Response (S282).

After a Joint Detection Phase (S274), the same processing as in the Joint Detection Phase (S3 in FIG. 5) is performed. Note that, in FIG. 39, the same processing as Mesh Network Phase (S1 in FIG. 5) is performed in a Mesh Network Phase (S271), and a backhaul link is measured in Backhaul Link Measurement (S272).

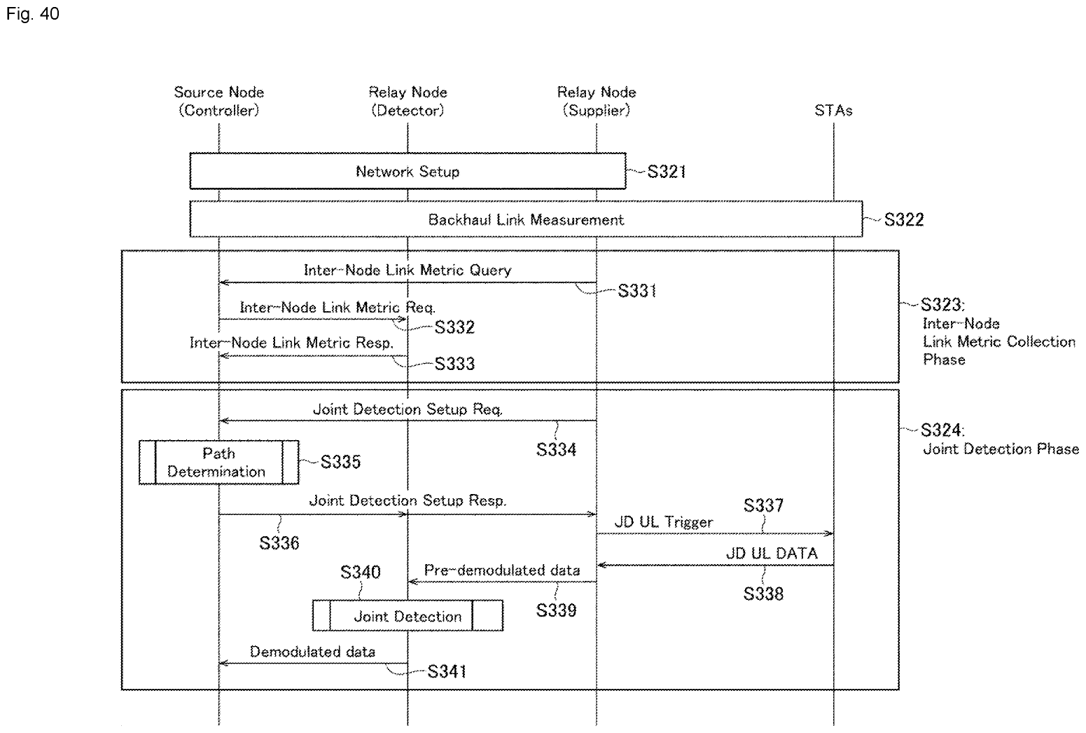

FIG. 40 is another example of a sequence diagram illustrating exchanges between devices along a time axis according to the third embodiment.

The overall sequence in FIG. 40 is different from the overall sequence in FIG. 39 in that a node (hereinafter referred to as a controller) that plays a role for centralized management of subordinate nodes is provided. In FIG. 40, a source node is a controller.

That is, a request source node transmits an Inter-Node Link Metric Query to the controller (S331), so that the controller collects parameter groups necessary to calculate a link metric value or a metric value from the surrounding node to the relay node 1 (Relay 1) (S332, S333). Further, a node that desires to perform Joint Detection necessarily transmits a Joint Detection Setup Request to the controller (S334) and is notified of a coordination node and its role in a Joint Detection Setup Response (S336) to perform processing of Joint Detection (S340).

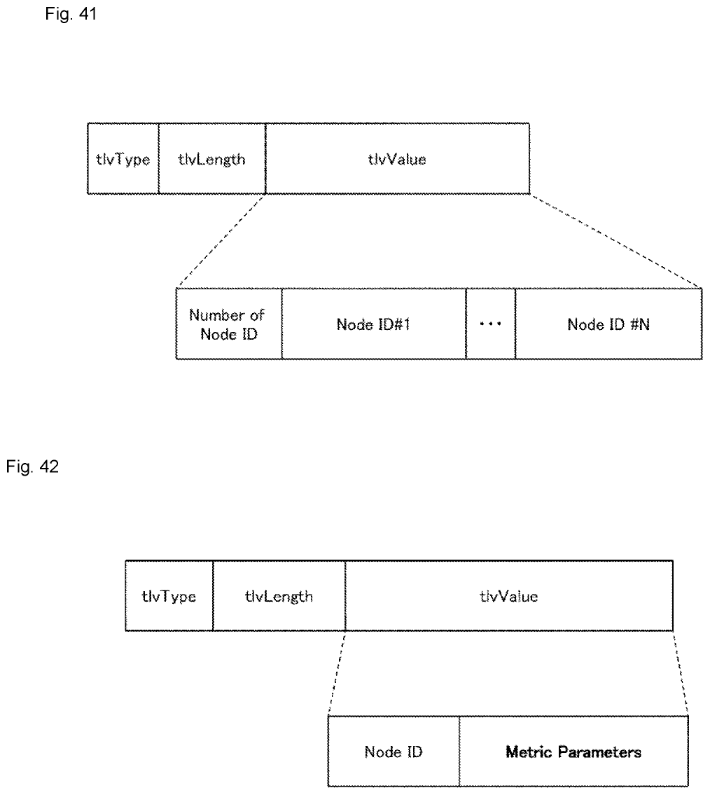

FIG. 41 is a diagram illustrating a configuration example of an Inter-Node Link Metric Request.

The Inter-Node Link Metric Request is constituted by tivType, tivLength, and tivValue. Here, a configuration based on IEEE1905 tiv (type-length-value) used in EasyMesh standardized by the Wi-Fi Alliance is shown.

The tivType includes information indicating that the TLV is an Inter-Node Link Metric Request. The tivLength includes information indicating the length of the TLV. The tivValue includes an information group to be notified of by the TLV. The tivValue includes a Number of Node ID and a Node ID.

The Number of Node ID includes the number of nodes for which the measurement of a link metric is requested. All nodes may be designated by entering a specific number (for example, 0). The Node ID includes identification information of a node for which the measurement of a link metric is requested. The identification information may be BSSID, BSS Color, or information uniquely assigned within a network.

Note that the Inter-Node Link Metric Request is not limited to the frame configuration illustrated in FIG. 41, and may include at least information of the Node Id illustrated in the drawing. Although it is assumed that the frame is stored in a TCP/IP Frame, the frame may be defined as a MAC Frame as long as necessary information is described therein.

FIG. 42 is a diagram illustrating a configuration example of an Inter-Node Link Metric Response.

The Inter-Node Link Metric Response is constituted by tivType, tivLength, and tivValue. Here, a configuration based on IEEE1905 tiv (type-length-value) used in EasyMesh standardized by the Wi-Fi Alliance is shown.

The tivType includes information indicating that the TLV is an Inter-Node Link Metric Response. The tivLength includes information indicating the length of the TLV. The tivValue includes an information group to be notified of by the TLV. The tivValue includes a Node ID and Metric Parameters.

The Node ID includes its own node identification information. The Metric Parameters include a link metric value from the node itself to a request node, or a parameter group necessary to calculate the metric value. The parameter group may be information necessary for Formula (3) or other information. For example, information such as RSSI and SNR may be used instead of a data rate value. Further, information such as a link usage rate and a busy rate may be included.

Note that the Inter-Node Link Metric Response is not limited to the frame configuration illustrated in FIG. 42, and may include at least the Metric Parameters illustrated in the drawing. Although it is assumed that the frame is stored in a TCP/IP Frame, the frame may be defined as a MAC Frame as long as necessary information is described therein.

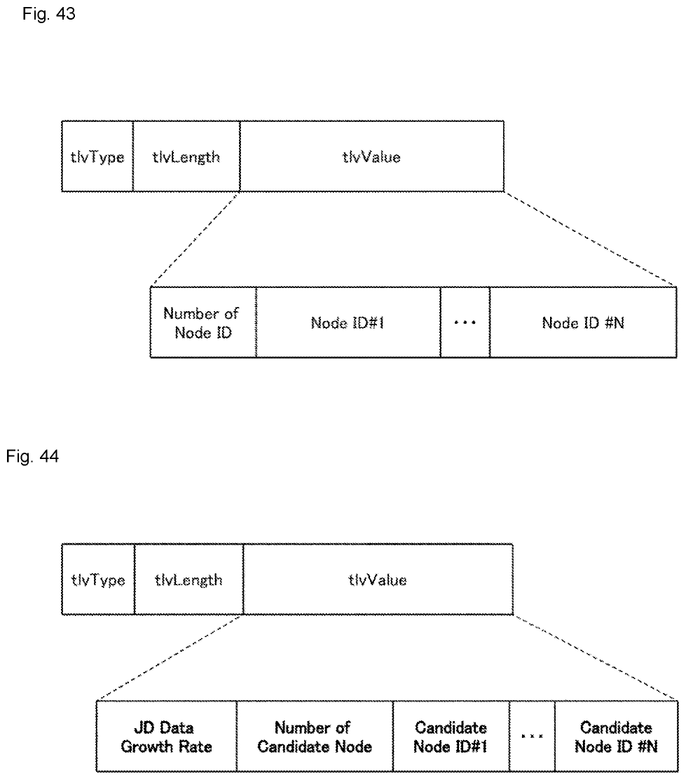

FIG. 43 is a diagram illustrating a configuration example of an Inter-Node Link Metric Query. Since the Inter-Node Link Metric Query in FIG. 43 is configured in the same manner as the Inter-Node Link Metric Request in FIG. 41, the description thereof is omitted.

FIG. 44 is a diagram illustrating a configuration example of a Joint Detection Setup Request. The Joint Detection Setup Request is constituted by tivType, tivLength, and tivValue. Here, a configuration based on IEEE1905 tiv (type-length-value) used in EasyMesh standardized by the Wi-Fi Alliance is shown.

The tivType includes information indicating that the TLV is a Joint Detection Setup Request. The tivLength includes information indicating the length of the TLV. The tivValue includes an information group to be notified of by the TLV. The tivValue includes a JD Data Growth Rate, a Number of Candidate Node, and a Candidate Node ID.

The JD Data Growth Rate includes information indicating a data growth rate when Pre-demodulated Data is transmitted. As in the first embodiment, numerical values determined by MCS and quantization bits of a UL signal are included. The Number of Candidate Node includes the number of nodes for which a Joint Detection request node desires to make a coordination request. All nodes may be designated by entering a specific number (for example, 0).

The Candidate Node ID includes identification information of a node for which a Joint Detection request node desires to make a coordination request. The identification information may be BSSID, BSS Color, or information uniquely assigned within a network.

Note that the Joint Detection Setup Request is not limited to the frame configuration illustrated in FIG. 44, and may include at least the JD Data Growth Rate and the Candidate Node ID illustrated in the drawing. Although it is assumed that the frame is stored in a TCP/IP Frame, the frame may be defined as a MAC Frame as long as necessary information is described therein.

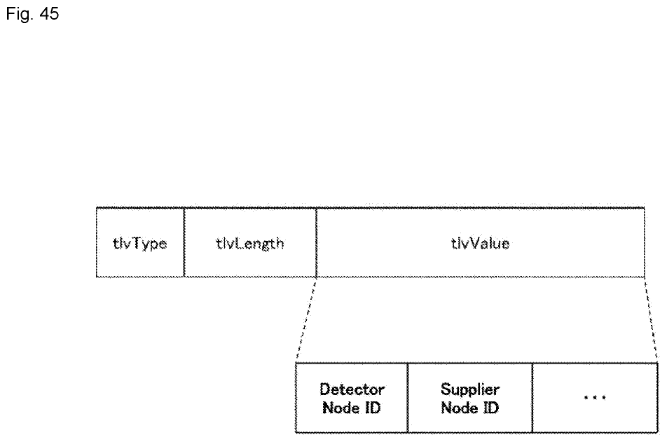

FIG. 45 is a diagram illustrating a configuration example of a Joint Detection Setup Response.

The Joint Detection Setup Response is constituted by tivType, tivLength, and tivValue. Here, a configuration based on IEEE1905 tiv (type-length-value) used in EasyMesh standardized by the Wi-Fi Alliance is shown.

The tivType includes information indicating that the TLV is a Joint Detection Setup Response. The tivLength includes information indicating the length of the TLV. The tivValue includes an information group to be notified of by the TLV. The tivValue includes a Detector Node ID and a Supplier Node ID.

The Detector Node ID includes identification information of a node that plays a role of a detector when Joint Detection is performed. The Supplier Node ID includes identification information of a node that plays a role of a supplier when Joint Detection is performed. The identification information may be BSSID, BSS Color, or information uniquely assigned within a network.

Note that the Joint Detection Setup Response is not limited to the frame configuration illustrated in FIG. 45, and may include at least the Detector Node ID and the Supplier Node ID illustrated in the drawing. Although it is assumed that the frame is stored in a TCP/IP Frame, the frame may be defined as a MAC Frame as long as necessary information is described therein.

As described above, the configuration and the processing of the tree-type network have been described in the third embodiment. In the communication device 10 that performs the above-described processing, the following processing is performed by at least one control unit of a control unit 100, a communication control unit 111, and a communication control unit 121. That is, the communication device 10 (for example, an access point AP) performs control for determining an optimum transmission route using a metric value with a surrounding node among a plurality of communication devices, and third parameters (for example, the Metric Parameters in FIG. 42) including values necessary to calculate the metric value.

By adopting the configuration in the third embodiment, for example, the following effects can be expected. That is, also in a tree-type network, it is possible to determine a coordination node and the role of Joint Detection at the time of performing Joint Detection by collecting link metric values between nodes and a parameter group necessary to calculate a link metric. Note that a series of processes of the communication device 10 described above can be executed by hardware or by software. When executing a series of processes by software, a program that constitutes the software is installed in the communication device 10. Further, the embodiments of the present technology are not limited to the above-described embodiments, and various modifications can be made without departing from the gist of the present technology. For example, in the above description, the embodiments have been described using the sequence diagrams, the frame configuration diagrams, and the flowcharts, but these embodiments are not necessarily limited to the configurations illustrated in the drawings and may be used differently depending on the situation. Further, the effects described in the specification are merely exemplary and not limiting, and other effects may be exhibited.

Note that the present technology can adopt the following configurations.

(1)

A communication device including:
a control unit that performs control for exchanging information used to determine a multi-hop transmission route with another communication device using wireless communication, and determining an optimum transmission route based on the amount of transmission data increased at the time of performing processing by a plurality of communication devices in cooperation when the transmission route is determined based on the information.

(2)

The communication device according to (1), wherein the control unit determines, as an optimum transmission route, a transmission route on the assumption that data before demodulation which has not been subjected to demodulation processing is transmitted to another communication device.

(3)

The communication device according to (1) or (2), wherein the control unit determines an optimum transmission route using first parameters including quantization bits of the data before demodulation, and a modulation method and a coding rate of an uplink signal.

(4)

The communication device according to (3), wherein the control unit calculates a metric value for coordination processing which is determined by the first parameters, and determines an optimum transmission route based on the calculated metric value.

(5)

The communication device according to (4), wherein the control unit transmits a frame that requests calculation of the metric value, inclusive of a value corresponding to the first parameters, an address for each a detector candidate node, which is a candidate for a node on a side that acquires the data before demodulation among the plurality of communication devices, and a metric value.

(6)

The communication device according to (4) or (5), wherein the control unit transmits a frame that responds to calculation of the metric value, inclusive of an address for each a detector candidate node, which is a candidate for a node on a side that acquires the data before demodulation among the plurality of communication devices, a metric value, and an address of a previous node.

(7)

The communication device according to (3), wherein the control unit determines an optimum transmission route based on a metric value calculated without taking the amount of transmission data increased into consideration, second parameters including values necessary for metric calculation to a detector candidate node, which is a candidate for a node on a side that acquires the data before demodulation among the plurality of communication devices, and the value corresponding to the first parameters.

(8)

The communication device according to (7), wherein the control unit transmits a frame that requests calculation of the metric value, inclusive of an address for each detector candidate node, a metric value, and a value corresponding to the second parameters.

(9)

The communication device according to (7) or (8), wherein the control unit transmits a frame that responds to calculation of the metric value, inclusive of an address for each detector candidate node, a metric value, a value corresponding to the second parameters, and an address of a previous node.

(10)

The communication device according to (1), wherein the control unit determines an optimum transmission route using a metric value with respect to a surrounding node among the plurality of communication devices, and third parameters including values necessary to calculate a metric value.

(11)

The communication device according to any one of (1) to (3), wherein the control unit determines a role of coordination processing based on an optimum transmission route determined for each of coordination candidate nodes included in the plurality of communication devices when the plurality of communication devices perform processing in cooperation.

(12)

The communication device according to (11), wherein the coordination candidate nodes are determined by a propagation loss or a positional relationship with other communication devices that induce an uplink signal.

(13)

The communication device according to (11) or (12), wherein the control unit determines a role of coordination processing so that a metric value is the smallest within an optimum transmission route for each of the coordination candidate nodes.

(14)

The communication device according to (13), wherein the control unit, in the role of coordination processing, determines a supplier, which is a node on a side that transmits the data before demodulation, or a detector, which is a node on a side that acquires the data before demodulation, among the plurality of communication devices.

(15)

The communication device according to any one of (11) to (14), wherein the control unit receives a frame that requests coordination processing which is transmitted from another communication device, and performs processing in cooperation with the other communication device in a role designated for the frame.

(16)

The communication device according to any one of (11) to (15) which is configured as an access point in a wireless LAN system.

(17)

A communication method performed by a communication device that exchanges information used to determine a multi-hop transmission route with another communication device using wireless communication, and determines an optimum transmission route based on the amount of transmission data increased at the time of performing processing by a plurality of communication devices in cooperation when the transmission route is determined based on the information.

(18)

A communication device comprising:
a control unit that receives a trigger signal which is transmitted from another communication device included in a plurality of communication devices that perform processing in cooperation in a multi-hop network, and transmits an uplink signal including a flag indicating execution of coordination processing and a PHY header in which node identification information according to a role of processing when the coordination processing is performed is set.

(19)

The communication device according to (18), wherein the control unit sets information included in the PHY header based on information included in the trigger signal.

(20)

The communication device according to (18) or (19) which is configured as a wireless terminal in a wireless LAN system.

### REFERENCE SIGNS LIST

10 Communication device
100 Control unit
101 Wireless communication unit
102 Wireless communication unit
103 Storage unit
104 WAN communication unit
111 Communication control unit
112 Communication storage unit
113 Data processing unit
114 Signal processing unit
115 Wireless interface unit
116 Amplification unit
117 Antenna
121 Communication control unit
122 Communication storage unit
123 Data processing unit
124 Signal processing unit
125 Wireless interface unit
126 Amplification unit
127 Antenna

1. A communication device comprising:
a control unit that performs control for exchanging information used to determine a multi-hop transmission route with another communication device using wireless communication, and determining an optimum transmission route based on the amount of transmission data increased at the time of performing processing by a plurality of communication devices in cooperation when the transmission route is determined based on the information.

2. The communication device according to claim 1, wherein the control unit determines, as an optimum transmission route, a transmission route on the assumption that data before demodulation which has not been subjected to demodulation processing is transmitted to another communication device.

3. The communication device according to claim 2, wherein the control unit determines an optimum transmission route using first parameters including quantization bits of the data before demodulation, and a modulation method and a coding rate of an uplink signal.

4. The communication device according to claim 3, wherein the control unit calculates a metric value for coordination processing which is determined by the first parameters, and determines an optimum transmission route based on the calculated metric value.

5. The communication device according to claim 4, wherein the control unit transmits a frame that requests calculation of the metric value, inclusive of a value corresponding to the first parameters, an address for each a detector candidate node, which is a candidate for a node on a side that acquires the data before demodulation among the plurality of communication devices, and a metric value.

6. The communication device according to claim 4, wherein the control unit transmits a frame that responds to calculation of the metric value, inclusive of an address for each a detector candidate node, which is a candidate for a node on a side that acquires the data before demodulation among the plurality of communication devices, a metric value, and an address of a previous node.

7. The communication device according to claim 3, wherein the control unit determines an optimum transmission route based on a metric value calculated without taking the amount of transmission data increased into consideration, second parameters including values necessary for metric calculation to a detector candidate node, which is a candidate for a node on a side that acquires the data before demodulation among the plurality of communication devices, and the value corresponding to the first parameters.

8. The communication device according to claim 7, wherein the control unit transmits a frame that requests calculation of the metric value, inclusive of an address for each detector candidate node, a metric value, and a value corresponding to the second parameters.

9. The communication device according to claim 7, wherein the control unit transmits a frame that responds to calculation of the metric value, inclusive of an address for each detector candidate node, a metric value, a value corresponding to the second parameters, and an address of a previous node.

10. The communication device according to claim 1, wherein the control unit determines an optimum transmission route using a metric value with respect to a surrounding node among the plurality of communication devices, and third parameters including values necessary to calculate a metric value.

11. The communication device according to claim 3, wherein the control unit determines a role of coordination processing based on an optimum transmission route determined for each of coordination candidate nodes included in the plurality of communication devices when the plurality of communication devices perform processing in cooperation.

12. The communication device according to claim 11, wherein the coordination candidate nodes are determined by a propagation loss or a positional relationship with other communication devices that induce an uplink signal.

13. The communication device according to claim 11, wherein the control unit determines a role of coordination processing so that a metric value is the smallest within an optimum transmission route for each of the coordination candidate nodes.

14. The communication device according to claim 13, wherein the control unit, in the role of coordination processing, determines a supplier, which is a node on a side that transmits the data before demodulation, or a detector, which is a node on a side that acquires the data before demodulation, among the plurality of communication devices.

15. The communication device according to claim 11, wherein the control unit receives a frame that requests coordination processing which is transmitted from another communication device, and performs processing in cooperation with the other communication device in a role designated for the frame.

16. The communication device according to claim 1 which is configured as an access point in a wireless LAN system.

17. A communication method performed by a communication device that exchanges information used to determine a multi-hop transmission route with another communication device using wireless communication, and determines an optimum transmission route based on the amount of transmission data increased at the time of performing processing by a plurality of communication devices in cooperation when the transmission route is determined based on the information.

18. A communication device comprising:
a control unit that receives a trigger signal which is transmitted from another communication device included in a plurality of communication devices that perform processing in cooperation in a multi-hop network, and transmits an uplink signal including a flag indicating execution of coordination processing and a PHY header in which node identification information according to a role of processing when the coordination processing is performed is set.

19. The communication device according to claim 18, wherein the control unit sets information included in the PHY header based on information included in the trigger signal.

20. The communication device according to claim 18 which is configured as a wireless terminal in a wireless LAN system.
